(19) United States
(12) Patent Application Publication
(10) Pub. No.: US 2026/0236720 A1
(43) Pub. Date: Aug. 13, 2026

(54) ELECTRONIC APPARATUS AND CONTROLLING METHOD THEREOF

(71) Applicant: Samsung Electronics Co., Ltd., Suwon-si (KR)

(72) Inventors: Seungyoon HEO, Suwon-si (KR); Hochul HWANG, Suwon-si (KR); Woojin CHO, Suwon-si (KR); Hunki LEE, Suwon-si (KR); Sanghoon LEE, Suwon-si (KR); Seongkwan YANG, Suwon-si (KR); Beakkwon SON, Suwon-si (KR)

(21) Appl. No.: 19/447,570

(22) Filed: Jan. 13, 2026

Related U.S. Application Data
(63) Continuation of application No. PCT/KR2026/000203, filed on Jan. 5, 2026.

(30) Foreign Application Priority Data
Feb. 13, 2025 (KR) 10-2025-0018889
Mar. 18, 2025 (KR) 10-2025-0034509

(51) Int. Cl. G06F 40/58

(52) U.S. Cl. CPC G06F 40/58

(57) ABSTRACT

An electronic apparatus is provided. The electronic apparatus includes memory, including one or more storage media, storing instructions, a communication circuit connected to an external device, and at least one processor including processing circuitry communicatively coupled to the memory and the communication circuit, wherein the instructions, when executed by the at least one processor individually or collectively, cause the electronic apparatus to receive a first voice of a first language uttered by a first user from the external device through the communication circuit, translate the first voice in a second language to obtain a first translation result, translate the first voice in a third language to obtain a second translation result, provide the first translation result to a second user, and provide the second translation result to a third user.

### CROSS-REFERENCE TO RELATED APPLICATION(S)

This application is a continuation application, claiming priority under 35 U.S.C. § 365(c), of an International application No. PCT/KR2026/000203, filed on Jan. 5, 2026, which is based on and claims the benefit of a Korean patent application number 10-2025-0018889, filed on Feb. 13, 2025, in the Korean Intellectual Property Office, and of a Korean patent application number 10-2025-0034509, filed on Mar. 18, 2025, in the Korean Intellectual Property Office, the disclosure of each of which is incorporated by reference herein in its entirety.

### TECHNICAL FIELD

The disclosure relates to an electronic apparatus and a controlling method thereof. More particularly, the disclosure relates to an electronic apparatus that provides a translation function in real-time and a controlling method thereof.

### BACKGROUND ART

Electronic apparatuses may provide a dialogue service between multi-users. A multi-user dialogue service may indicate a voice call, a video call, and the like. In providing the multi-user dialogue service, the electronic apparatus may provide a translation function. The translation function may indicate a function that performs translation into a determined language with respect to an utterance (or text) input of a specific user.

In case of a 1:1 dialogue service, a translation result may be generated using only two languages. However, in case of a dialogue service between three or more users, there is a need for three or more languages to be applied in the translation function. Accordingly, there has been a problem of it being difficult for a translation function using a plurality of languages to be performed through one electronic apparatus.

In addition, in case a plurality of users participate in the dialogue service, there has been the inconvenience of all users having to install the same application. In a situation of two or more users using different languages participating in the dialogue service with one terminal device, there has been the inconvenience of two translation results not being provided.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic apparatus that provides relation results for a plurality of users who use different languages individually in one electronic apparatus and a controlling method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes memory, including one or more storage media, storing instructions, a communication circuit connected to an external device, and at least one processor including processing circuitry communicatively coupled to the memory and the communication circuit, wherein the instructions, when executed by the at least one processor individually or collectively, cause the electronic apparatus to receive a first voice of a first language uttered by a first user from the external device through the communication circuit, translate the first voice in a second language to obtain a first translation result, translate the first voice in a third language to obtain a second translation result, provide the first translation result to a second user, and provide the second translation result to a third user.

The first translation result includes at least one of a second text or a second voice translated based on the second language, and the second translation result includes at least one of a third text or a third voice translated based on the third language.

The instructions, when executed by the at least one processor individually or collectively, cause the electronic apparatus to, based on the first voice being received, obtain a first text of the first voice, translate the first text in the second language to obtain the second text, and translate the first text in the third language to obtain the third text.

The electronic apparatus includes a display, and the instructions, when executed by the at least one processor individually or collectively, cause the electronic apparatus to determine a first area corresponding to the second user among an entire area of the display, determine a second area corresponding to the third user among the entire area of the display, display the second text in the first area, and display the third text in the second area.

The instructions, when executed by the at least one processor individually or collectively, cause the electronic apparatus to display the first text and the second text in the first area together, and display the first text and the third text in the second area together.

The first area is a left area of the second area.

The instructions, when executed by the at least one processor individually or collectively, cause the electronic apparatus to obtain the second voice corresponding to the second text based on a voice generation function for converting text data to audio data, and obtain the third voice corresponding to the third text based on the voice generation function.

The instructions, when executed by the at least one processor individually or collectively, cause the electronic apparatus to obtain the second voice based on the first voice and the second text, and obtain the third voice based on the first voice and the third text.

The instructions, when executed by the at least one processor individually or collectively, cause the electronic apparatus to determine a first output device corresponding to the second user, determine a second output device corresponding to the third user, transmit the second voice to the first output device, and transmit the third voice to the second output device.

The first output device or the second output device is one of at least one speaker included in the electronic apparatus or an earphone connectable to the electronic apparatus.

In accordance with another aspect of the disclosure, a method of controlling an electronic apparatus is provided. The method includes receiving a first voice of a first language uttered by a first user from an external device, translating the first voice in a second language to obtain a first translation result, translating the first voice in a third language to obtain a second translation result, providing the first translation result to a second user, and providing the second translation result to a third user.

The first translation result includes at least one of a second text or a second voice translated based on the second language, and the second translation result includes at least one of a third text or a third voice translated based on the third language.

The obtaining the first translation result and the second translation result includes based on the first voice being received, obtaining the first text of the first voice, translating the first text in a second language to obtain the second text, and translating the first text in a third language to obtain the third text.

The electronic apparatus includes a display, and the providing the first translation result and the second translation result includes determining a first area corresponding to the second user among an entire area of the display, determining a second area corresponding to the third user among the entire area of the display, displaying the second text in the first area, and displaying the third text in the second area.

The providing the first translation result and the second translation result includes displaying the first text and the second text in the first area together, and displaying the first text and the third text in the second area together.

The first area is a left area of the second area.

The obtaining the first translation result and the second translation result includes obtaining the second voice corresponding to the second text based on a voice generation function for converting text data to audio data, and obtaining the third voice corresponding to the third text based on the voice generation function.

The obtaining the first translation result and the second translation result includes obtaining the second voice based on the first voice and the second text, and obtaining the third voice based on the first voice and the third text.

The providing the first translation result and the second translation result includes determining a first output device corresponding to the second user, determining a second output device corresponding to the third user, transmitting the second voice to the first output device, and transmitting the third voice to the second output device.

The first output device or the second output device is one of at least one speaker included in the electronic apparatus or an earphone connectable to the electronic apparatus.

One or more non-transitory computer-readable storage media storing one or more computer programs including computer-executable instruction that, when executed by one or more processors of an electronic apparatus individually or collectively, cause the electronic apparatus to perform operations are provided. The operations include receiving a first voice of a first language uttered by a first user from an external device, translating the first voice in a second language to obtain a first translation result, translating the first voice in a third language to obtain a second translation result, providing the first translation result to a second user, and providing the second translation result to a third user.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating multi-translation according to an embodiment of the disclosure;

FIG. 2 is a block diagram illustrating an electronic apparatus according to an embodiment of the disclosure;

FIG. 3 is a block diagram illustrating a configuration of an electronic apparatus according to an embodiment of the disclosure;

FIG. 4 is a diagram illustrating an operation for outputting a multi-translation result according to an embodiment of the disclosure;

FIG. 5 is a diagram illustrating a translation management module according to an embodiment of the disclosure;

FIG. 6 is a diagram illustrating a receive channel and a transmit channel according to an embodiment of the disclosure;

FIG. 7 is a diagram illustrating an output channel according to an embodiment of the disclosure;

FIG. 8 is a diagram illustrating an operation for providing multi-translation in an image according to an embodiment of the disclosure;

FIG. 9 is a diagram illustrating an operation for providing multi-translation in audio according to an embodiment of the disclosure;

FIG. 10 is a diagram illustrating an operation for providing multi-translation in an image and in audio according to an embodiment of the disclosure;

FIG. 11 is a diagram illustrating an operation for displaying a subject of translation and a translation result in separated areas according to an embodiment of the disclosure;

FIG. 12 is a diagram illustrating time-points for outputting an original voice and a translated voice according to an embodiment of the disclosure;

FIG. 13 is a diagram illustrating a basic operation of multi-translation according to an embodiment of the disclosure;

FIG. 14 is a diagram illustrating an operation for obtaining a setting of multi-translation according to an embodiment of the disclosure;

FIG. 15 is a diagram illustrating an operation for obtaining a multi-translation result according to an embodiment of the disclosure;

FIG. 16 is a diagram illustrating an operation for providing a multi-translation result according to an embodiment of the disclosure;

FIG. 17 is a diagram illustrating a voice recognition module according to an embodiment of the disclosure;

FIG. 18 is a diagram illustrating an operation for obtaining a translation result according to an embodiment of the disclosure;

FIG. 19 is a diagram illustrating a screen showing a translation function according to an embodiment of the disclosure;

FIG. 20 is a diagram illustrating a screen guiding multi-translation according to an embodiment of the disclosure;

FIG. 21 is a diagram illustrating a screen for setting of multi-translation according to an embodiment of the disclosure;

FIG. 22 is a diagram illustrating a screen for selecting output devices according to an embodiment of the disclosure;

FIG. 23 is a diagram illustrating a screen for guiding real-time interpretation according to an embodiment of the disclosure;

FIG. 24 is a diagram illustrating a setting screen associated with real-time interpretation according to an embodiment of the disclosure;

FIG. 25 is a diagram illustrating an operation of an electronic apparatus providing multi-translation by receiving voice directly according to an embodiment of the disclosure;

FIG. 26 is a diagram illustrating a translation management module according to an embodiment of the disclosure;

FIG. 27 is a diagram illustrating an operation of an electronic apparatus providing multi-translation based on a received voice according to an embodiment of the disclosure;

FIG. 28 is a diagram illustrating an operation of an electronic apparatus providing a translation result based on a received voice according to an embodiment of the disclosure;

FIG. 29 is a diagram illustrating a time-point for outputting a translation result according to an embodiment of the disclosure;

FIG. 30 is a diagram illustrating various structures of an electronic apparatus according to an embodiment of the disclosure;

FIG. 31 is a diagram illustrating an operation for providing a translation result in an image through an electronic apparatus of a first structure according to an embodiment of the disclosure;

FIG. 32 is a diagram illustrating an operation for providing a translation result in audio through an electronic apparatus of a first structure according to an embodiment of the disclosure;

FIG. 33 is a diagram illustrating an operation for providing a translation result in an image and in audio through an electronic apparatus of a first structure according to an embodiment of the disclosure;

FIG. 34 is a diagram illustrating an operation for providing a translation result in an image and in audio through an electronic apparatus of a first structure according to an embodiment of the disclosure;

FIG. 35 is a diagram illustrating an operation of an electronic apparatus of a first structure for not outputting a received voice and providing only a translation result according to an embodiment of the disclosure;

FIG. 36 is a diagram illustrating an operation for providing a translation result in an image through an electronic apparatus of a third structure according to an embodiment of the disclosure;

FIG. 37 is a diagram illustrating an operation for providing a translation result in audio through an electronic apparatus of a third structure according to an embodiment of the disclosure;

FIG. 38 is a diagram illustrating an operation for providing a translation result in an image and in audio through an electronic apparatus of a third structure according to an embodiment of the disclosure;

FIG. 39 is a diagram illustrating an operation for providing a translation result in an image and in audio through an electronic apparatus of a third structure according to an embodiment of the disclosure;

FIG. 40 is a diagram illustrating an operation of an electronic apparatus of a third structure not outputting a received voice and providing only a translation result according to an embodiment of the disclosure; and

FIG. 41 is a diagram illustrating a controlling method of an electronic apparatus according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, expressions, such as “have”, “may have”, “include”, and “may include” are used to designate a presence of a corresponding characteristic (e.g., elements, such as numerical value, function, operation, or component), and not to preclude a presence or a possibility of additional characteristics.

The expression at least one of A and/or B is to be understood as indicating any one of “A” or “B” or “A and B”.

Expressions, such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

It is to be understood that the terms, such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

In the disclosure, the term “user” may refer to a person using an electronic apparatus or an apparatus (e.g., artificial intelligence electronic apparatus) using an electronic apparatus.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

An embodiment of the disclosure will be described below with reference to the accompanied drawings.

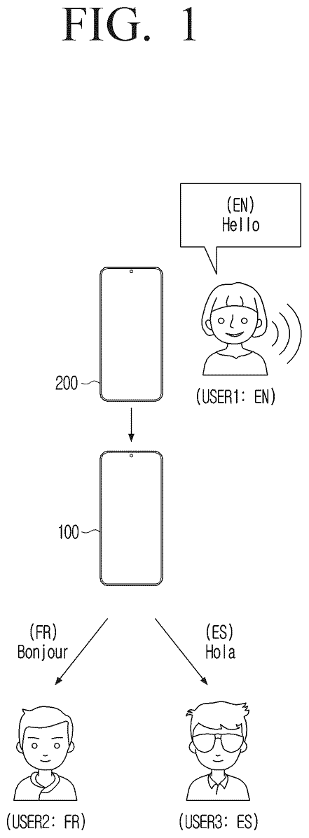

FIG. 1 is a diagram illustrating multi-translation according to an embodiment of the disclosure.

Referring to FIG. 1, an electronic apparatus 100 may receive a first voice of a first user from an external device 200. The first voice may be in a first language.

The electronic apparatus 100 may provide multi-translation based on the first voice in the first language. The multi-translation may indicate an operation for translating into a plurality of languages with respect to an input voice (first voice). The electronic apparatus 100 may provide multi-translation to a second user and a third user. It may be assumed that the second user uses a second language, and the third user uses a third language.

The electronic apparatus 100 may perform multi-translation in pre-set languages (second language, third language). The electronic apparatus 100 may translate the first voice to each of the second language and the third language. The electronic apparatus 100 may provide a translation result in the second language to the second user. The electronic apparatus 100 may provide a translation result in the third language to the third user.

The translation result may include at least one of image data or audio data. The electronic apparatus 100 may provide at least one of a translation result in an image form or a translation result in an audio form.

For example, it may be assumed that the first user uttered the first voice (EN, Hello). The external device 200 may transmit the first voice (EN, Hello) to the electronic apparatus 100.

The electronic apparatus 100 may translate the first voice (EN, Hello) to obtain a first translation result (FR, Bonjour). The electronic apparatus 100 may provide the first translation result (FR, Bonjour) to the second user.

The electronic apparatus 100 may translate the first voice (EN, Hello) to obtain a second translation result (ES, Hola). The electronic apparatus 100 may provide the second translation result (ES, Hola) to the third user.

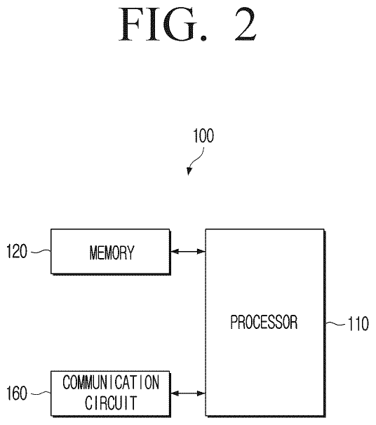

FIG. 2 is a block diagram illustrating an electronic apparatus according to an embodiment of the disclosure.

Referring to FIG. 2, the electronic apparatus 100 may include at least one processor 110 including processing circuitry, memory 120 storing instructions, and a communication circuit 160 connected to the external device 200.

The at least one processor 110 may receive, through the communication circuit 160, the first voice in the first language uttered by the first user from the external device 200.

The external device 200 may perform communication with the electronic apparatus 100. The first user of the external device 200 may dialogue with a user of the electronic apparatus 100. As an example, the user of the electronic apparatus 100 may be in plurality. A plurality of users may be a second user and a third user.

The at least one processor 110 may provide a dialogue service to the first user, the second user, and the third user. The dialogue service may include a voice call, a video call, and the like. The dialogue service may be described as a dialogue function.

As an example, a first space in which the first user is present and a second space in which the second user and the third user are present may be different.

The first user, the second user, and the third user may use different languages from one another. The at least one processor 110 may provide a translation function to the second user and the third user present in the second space.

The at least one processor 110 may obtain the first translation result by translating the first voice to the second language. The at least one processor 110 may obtain the second translation result by translating the first voice to the third language.

The at least one processor 110 may provide the first translation result to the second user. The at least one processor 110 may provide the second translation result to the third user.

The first translation result may include at least one of a second text or a second voice translated based on the second language.

The second translation result may include at least one of a third text or a third voice translated based on the third language.

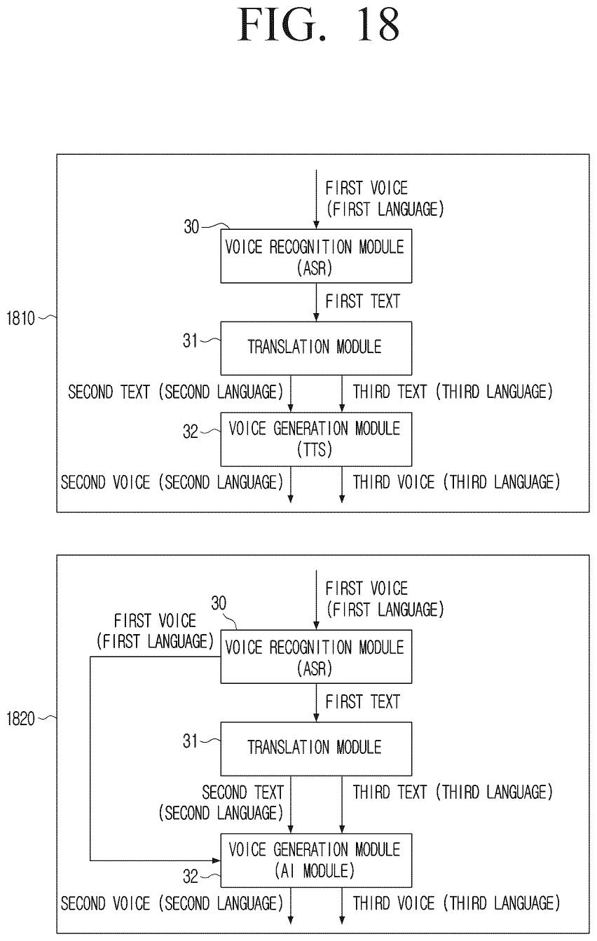

The at least one processor 110 may obtain, based on the first voice being received, the first text of the first voice. The at least one processor 110 may translate the first text in the second language to obtain the second text. The at least one processor 110 may translate the first text in the third language to obtain the third text. Descriptions associated therewith will be described in embodiment 1810 of FIG. 18.

The electronic apparatus 100 may include a display 140.

The at least one processor 110 may determine a first area corresponding to the second user among an entire area of the display 140. The at least one processor 110 may determine a second area corresponding to the third user among the entire area of the display 140. As an example, the first area may be left area of the second area.

The at least one processor 110 may display the second text in the first area. The at least one processor 110 may display the third text in the second area.

The at least one processor 110 may display the first text and the second text in the first area together. The at least one processor 110 may display the first text and the third text in the second area together.

The at least one processor 110 may obtain the second voice corresponding to the second text based on a voice generation function for converting text data to audio data. The at least one processor 110 may obtain the third voice corresponding to the third text based on the voice generation function. Descriptions associated therewith will be described in embodiment 1810 of FIG. 18.

The at least one processor 110 may provide a translation result in an audio data form. The at least one processor 110 may perform a function converting text to audio.

The at least one processor 110 may obtain the second voice based on the first voice and the second text. The at least one processor 110 may obtain the third voice based on the first voice and the third text. Descriptions associated therewith will be described in embodiment 1820 of FIG. 18. The at least one processor 110 may obtain the second voice and the third voice having a similar voiceprint (or voice) as the first user through the first voice.

The at least one processor 110 may determine a first output device corresponding to the second user. The at least one processor 110 may determine a second output device corresponding to the third user.

The at least one processor 110 may transmit the second voice to the first output device. The at least one processor 110 may transmit the third voice to the second output device.

The first output device or the second output device may be one of at least one speaker included in the electronic apparatus 100 or an earphone connectable to the electronic apparatus 100.

As an example, the first output device (or second output device) may be at least one speaker included in the electronic apparatus 100. The at least one speaker may be one of a main speaker or a sub speaker included in the electronic apparatus 100.

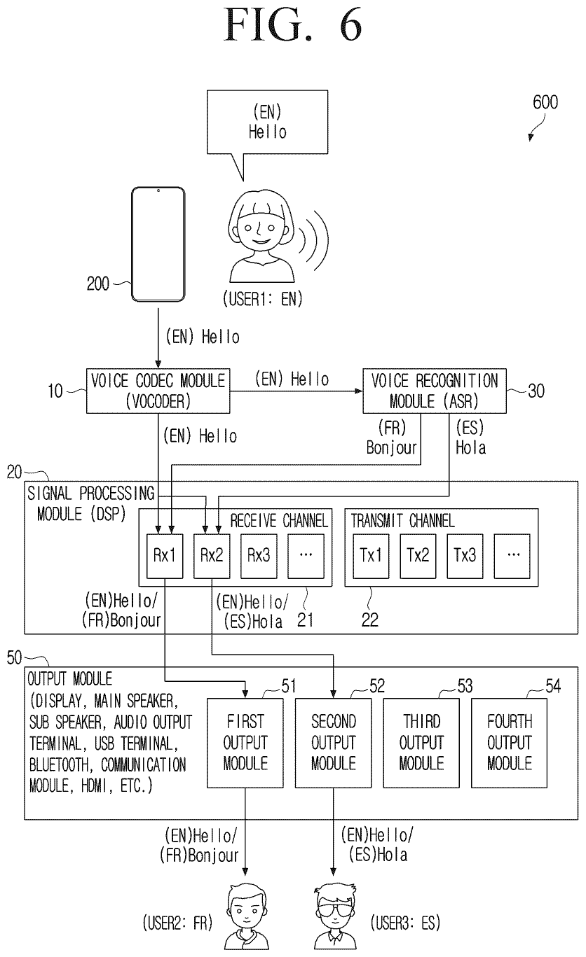

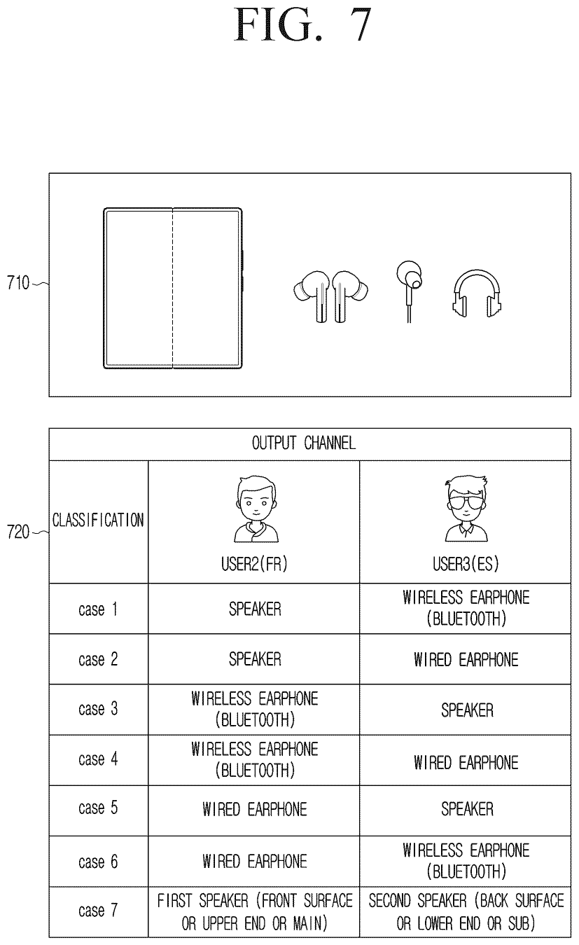

As an example, the first output device (or second output device) may be an earphone connectable to the electronic apparatus 100. The connectable earphone may indicate an earphone to which data is transmittable through the communication circuit 160 or an input and output terminal. The input and output terminal may indicate a terminal connectable via wire with the electronic apparatus 100. Descriptions associated therewith will be described in FIGS. 6 and 7.

The translation result may be provided based on at least one of image data or audio data.

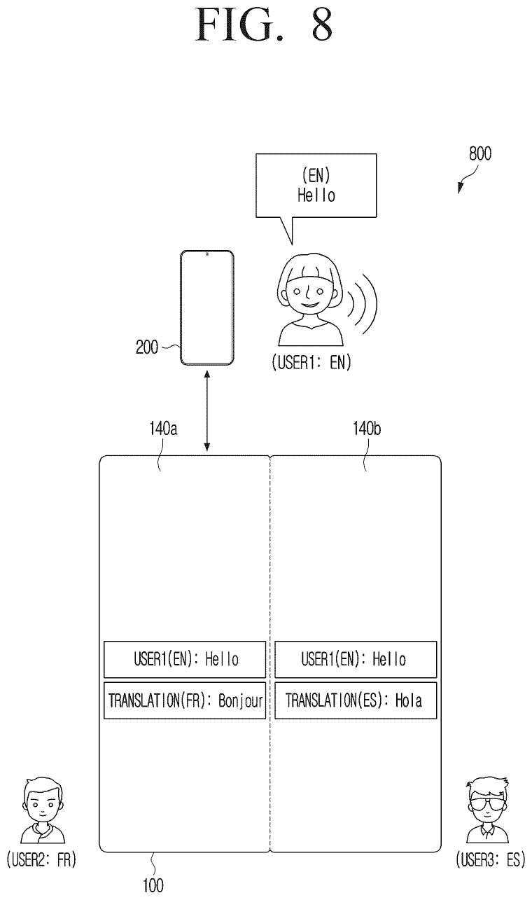

As an example, the at least one processor 110 may provide the translation result as image data. Descriptions associated therewith will be described in FIGS. 8, 31, and 36.

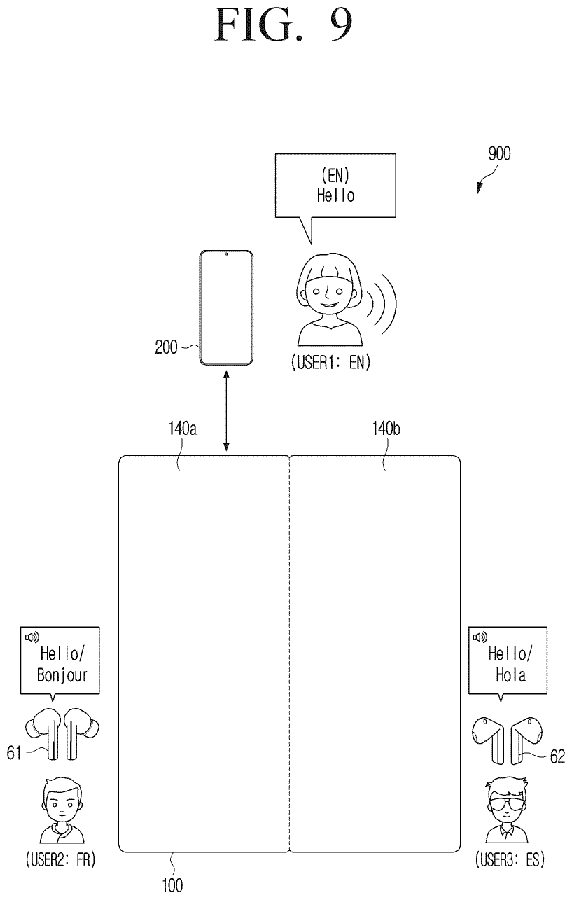

As an example, the at least one processor 110 may provide the translation result as audio data. Descriptions associated therewith will be described in FIGS. 9, 32, and 37.

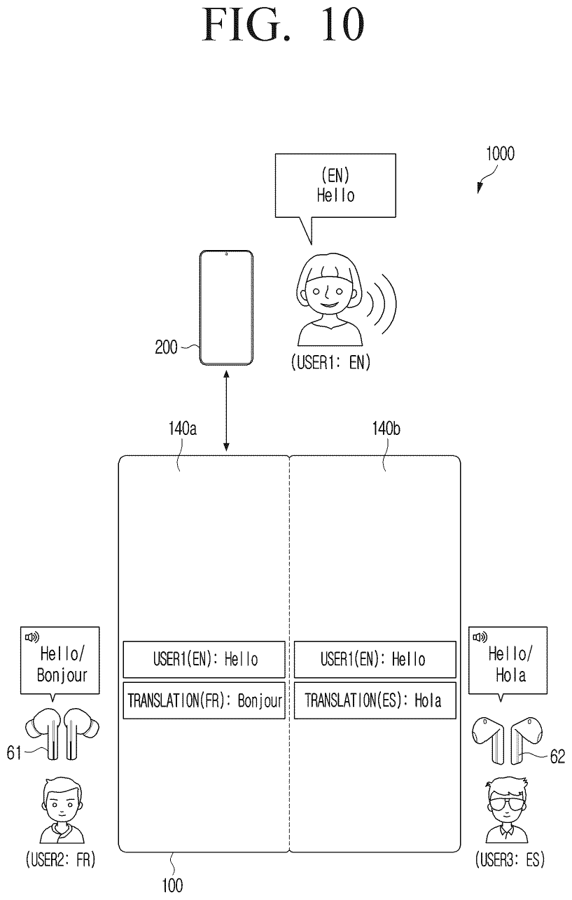

As an example, the at least one processor 110 may provide the translation result as image data and audio data. Descriptions associated therewith will be described in FIGS. 10, 33, and 38.

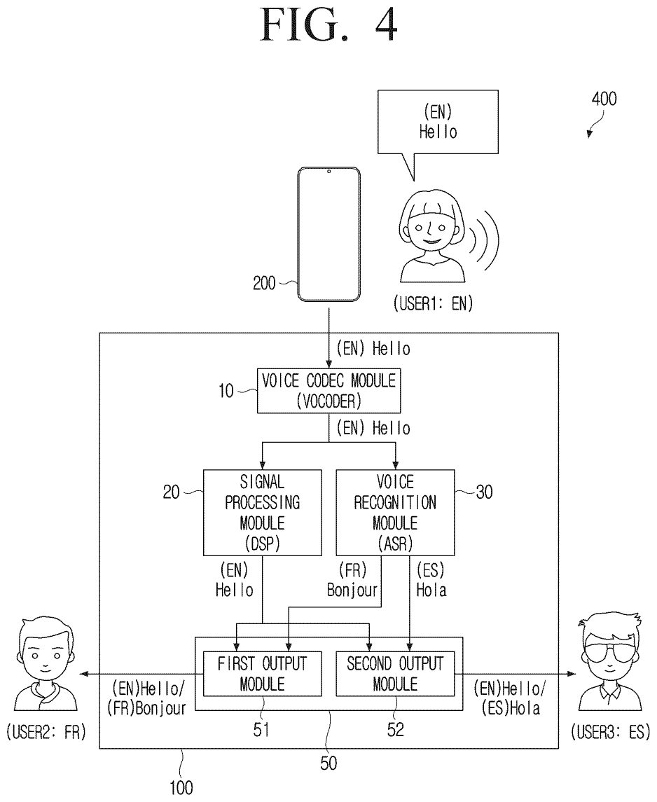

Operations for generating the first translation result and the second translation result by analyzing the first voice uttered by the first user will be described in FIGS. 4 to 6.

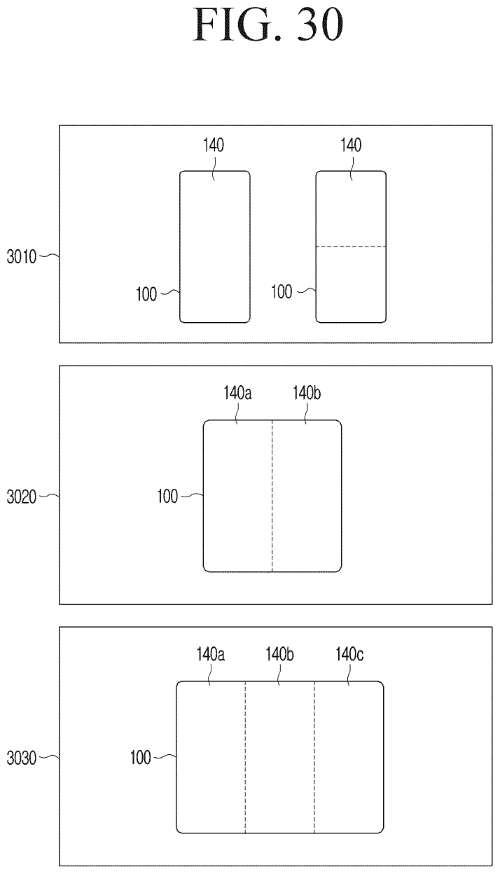

The electronic apparatus 100 may be implemented in various structures. Descriptions associated therewith will be described in FIG. 30.

As an example, the electronic apparatus 100 may be implemented in a first structure including only one panel. The electronic apparatus 100 of the first structure may include a display that is unfoldable.

As an example, the electronic apparatus 100 may be implemented in the first structure that includes two panels foldable in a horizontal direction. The electronic apparatus 100 of the first structure may include a display that is foldable in the horizontal direction.

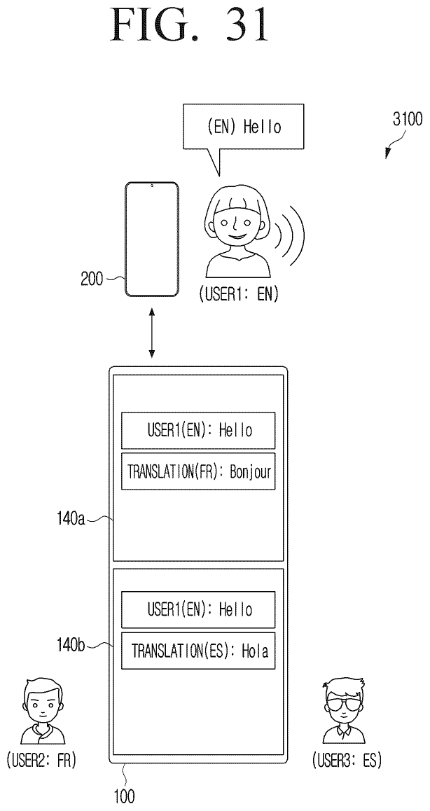

The electronic apparatus 100 that includes the display that is unfoldable or the display that is foldable in the horizontal direction may be indicated in the first structure. The electronic apparatus 100 of the first structure will be described in FIGS. 31 to 35.

As an example, the electronic apparatus 100 may be implemented in a second structure that includes two panels which are foldable in a vertical direction. The electronic apparatus 100 of the second structure may include a display foldable once in the vertical direction. The electronic apparatus 100 of the second structure will be described in FIGS. 8 to 11.

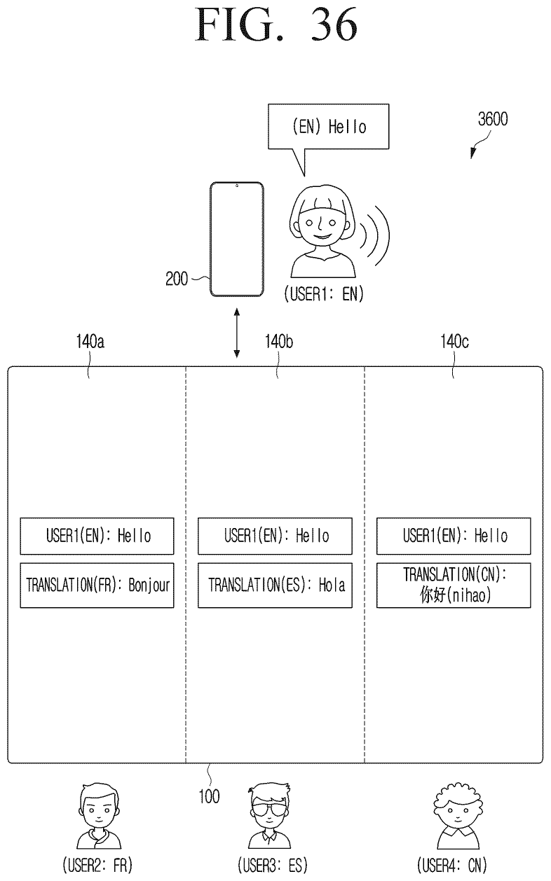

As an example, the electronic apparatus 100 may be implemented in a third structure that includes three panels which are foldable twice in the vertical direction. The electronic apparatus 100 of the third structure may include a display foldable twice in the vertical direction. The electronic apparatus 100 of the third structure will be described in FIGS. 36 to 40.

The electronic apparatus 100 may identify a plurality of areas by dividing the display 140, and provide a translation result for each user in each area. When the screen is divided in plurality, translation results in various languages may be simultaneously displayed. If the user of the electronic apparatus 100 is in plurality and language being used is different, multi-translation may be provided through one electronic apparatus 100.

According to an embodiment of the disclosure, the electronic apparatus 100 may generate a dialogue service screen using a multi-fold function. When a plurality of users use the dialogue service screen, the electronic apparatus 100 may divide the dialogue service screen based on a multi-folding line. Descriptions associated therewith will be described in FIG. 30. The multi-folding line may indicate a line by which an electronic apparatus formed of a plurality of panels is folded. The electronic apparatus 100 may use the multi-folding line as a basis for dividing the display 140. The display 140 of the electronic apparatus 100 may have characteristics of being bent according to the folding of the panels.

According to an embodiment of the disclosure, the electronic apparatus 100 may perform the translation function in an on-device form. The electronic apparatus 100 may not transmit data to an external server for the translation function. The electronic apparatus 100 may perform the translation function using only a model or a module inside the electronic apparatus 100.

According to an embodiment of the disclosure, the electronic apparatus 100 may provide (or playback) simultaneous translation between multi-users. For the dialogue service for the first user using the external device 200 and the second user and the third user using the electronic apparatus 100, the electronic apparatus 100 may perform a simultaneous translation function between multi-users.

According to an embodiment of the disclosure, the electronic apparatus 100 may display the first translation result and the second translation result in different displays from each other. It may be assumed that the second user is the user of the electronic apparatus 100, and the third user is the user of the external device. The external device of the third user may be connected to the electronic apparatus 100. The external device may include a display. As an example, the external device may be one of a smartphone, a tablet, or a smart watch. The electronic apparatus 100 may display the first translation result on the display 140 of the electronic apparatus 100. The electronic apparatus 100 may transmit the second translation result to the external device of the third user. The external device of the third user may display the second translation result through the display included in the external device. Here, if an additional output device corresponding to a fourth user is connected, the electronic apparatus 100 may provide a translation result for the fourth user to the output device of the fourth user.

The device used by the first user may be described as the external device 200, and the device used by the second user or the third user may be described as an external device.

According to an embodiment of the disclosure, the electronic apparatus 100 may apply a real-time translation function to a dialogue service carried out through commercial networks, such as second generation (2G), third generation (3G), fourth generation (4G), fifth generation (5G), or the like.

According to an embodiment of the disclosure, the electronic apparatus 100 may apply the real-time translation function to a dialogue service which uses voice over Internet protocol (VOIP).

According to an embodiment of the disclosure, the electronic apparatus 100 may provide a real-time multi-lingual interpretation function through a multi-screen division used in situations, such as conference meetings, forums, and the like.

According to an embodiment of the disclosure, the electronic apparatus 100 may apply the real-time translation function to extended reality (XR), virtual reality (VR), augmented reality (AR), and the like.

The electronic apparatus 100 may display a translation result of the real-time translation function on the display 140. There may be various display methods.

As an example, the electronic apparatus 100 may display the translation result in a portion of an area of the dialogue service screen.

As an example, the electronic apparatus 100 may display the translation result using a separate pop-up user interface (UI) or a pop-up window displaying the dialogue service screen.

As an example, the electronic apparatus 100 may display the translation result using a message UI, or a notification UI while displaying the dialogue service screen.

The electronic apparatus 100 may receive input of a final command of the user for providing the translation result of the real-time translation function. The above-described method for providing the translation result may also be identically applied to a guide UI for receiving input of the final command of the user. The guide UI may be displayed in a portion of an area of the dialogue service screen, or displayed as a pop-up UI, or displayed as message UI, or the like. When the final command of the user is input through the guide UI, the electronic apparatus 100 may provide the real-time translation function.

According to an embodiment of the disclosure, information of the user participating in the dialogue service may be pre-stored in the electronic apparatus 100. For example, a phone number of the user may be pre-stored, or may be pre-registered as a friend. If the languages of the plurality of users using the electronic apparatus 100 have been pre-registered, the electronic apparatus 100 may directly provide the real-time translation function without displaying a separate additional guide screen.

According to an embodiment of the disclosure, the electronic apparatus 100 may add a new user while performing the real-time translation function. When a new user is added and the language of the new user is identified, the electronic apparatus 100 may change the existing screen division configuration to suit the new user.

According to an embodiment of the disclosure, the electronic apparatus 100 may change the language set while performing the real-time translation function. The real-time translation function may be provided while the set language is wrongly selected. The electronic apparatus 100 may receive a user input for changing the language through a setting screen while performing the real-time translation function. When the user input is received, the electronic apparatus 100 may provide a translation result based on the changed language.

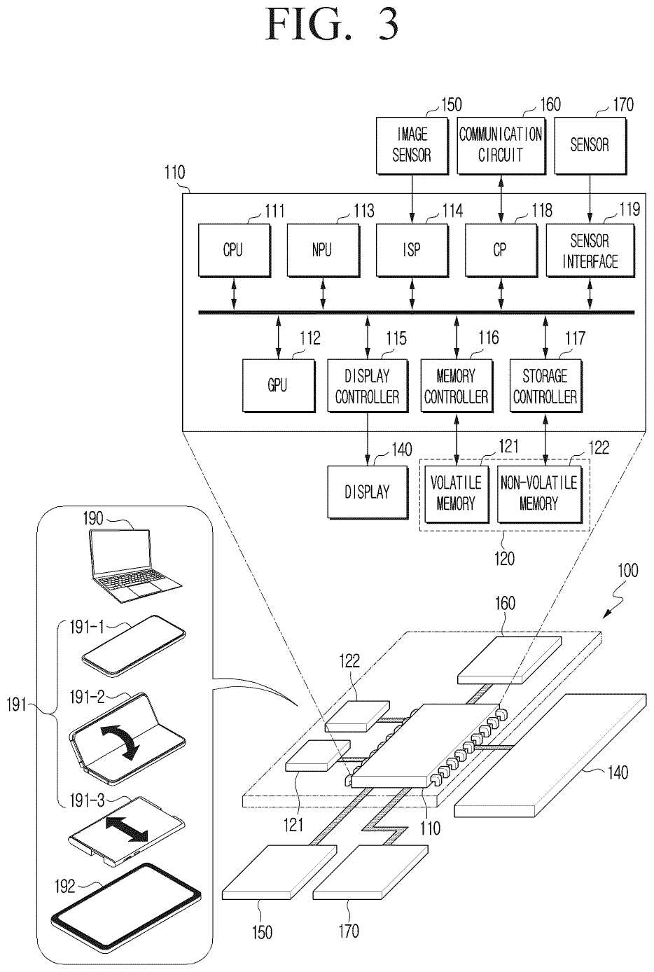

FIG. 3 is a block diagram illustrating a configuration of an electronic apparatus according to an embodiment of the disclosure.

FIG. 3 is a block diagram of an electronic apparatus capable of performing operations described in the disclosure.

Referring to FIG. 3, the electronic apparatus 100 may be one of electronic apparatuses of various forms, such as a notebook 190, smartphones 191 having various form factors (e.g., a bar-type smartphone 191-1, a foldable-type smartphone 191-2, or a slidable (or rollable)-type smartphone 191-3, a tablet 192, a cellular phone (not shown), and other similar computing devices (not shown). Elements shown in FIG. 3, relationships thereof, and functions thereof, are merely examples, and is not intended to limit the implementations described or claimed in the disclosure. The electronic apparatus 100 may be referred to as a mobile device, a user device, a multi-function device, a portable device, or a server.

The electronic apparatus 100 may include elements that include the at least one processor 110 (hereinafter, referred to as a processor 110), at least one memory 120 (hereinafter, referred to as memory 120), at least one display 140 (hereinafter, referred to as the display 140), at least one image sensor 150 (hereinafter, referred to as an image sensor 150), at least one communication circuit 160 (hereinafter, referred to as a communication circuit 160), and/or at least one sensor 170 (hereinafter, referred to as a sensor 170). The elements above are merely examples. For example, the electronic apparatus 100 may include other elements (e.g., a power management integrated circuitry (PMIC), an audio processing circuit, an antenna, a rechargeable battery, or an input and output interface). For example, a portion of the elements may be omitted from the electronic apparatus 100. For example, a few elements may be integrated into one element.

The processor 110 may be implemented as one or more integrated circuits (or circuitry) (ICs), and execute various data processing. The processor 110 may include at least one electrical circuit, and may individually or collectively distribute and process instructions (or programs, data) stored in the memory 120. The processor 110 may include a combination of processors including one or more processing circuitry. The processor 110 may include any operative processing circuitry for controlling performances and operations of one or more elements (e.g., the memory 120, the display 140, the image sensor, the communication circuit 160, and/or the sensor 170) of the electronic apparatus 100. For example, the processor 110 (e.g., an application processor (AP)) may be implemented as a system on chip (SoC) (e.g., one chip or a chip set). For example, the processor 110 may be implemented with a plurality of cores (or at least one core circuit), a plurality of chips, or a plurality of chip sets. For example, the processor 110 may include one or more processing circuitry. For example, the processor 110 may include one or more processing circuitry configured to individually and/or collectively perform several functions of the disclosure. As an unlimited example, at least a portion of the processor 110 may be included in a first chip of the electronic apparatus 100, and at least another portion of the processor 110 may be included in a second chip of the electronic apparatus 100 different from the first chip of the electronic apparatus 100.

For example, the processor 110 may include a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. The above-described elements of the processor 110 are merely examples. For example, the processor 110 may further include other elements. For example, a few elements of the processor 110 may be omitted from the processor 110. For example, a few elements of the processor 110 may be included as separate elements of the electronic apparatus 100 outside of the processor 110. For example, a portion of the elements (e.g., memory controller 116) of the processor 110 may be included in other elements (e.g., at least a portion of the memory 120, an interface (e.g., useable for connecting to at least one element of the electronic apparatus 100), the display 140, and/or the image sensor 150).

The processor 110 may cause other elements of the electronic apparatus 100 to perform various operations by executing the instructions stored in the memory 120. The CPU 111 (or a central processing circuit) may be configured to control elements of the processor 110 based on execution of the instructions stored in the memory 120 (e.g., volatile memory 121 and/or non-volatile memory 122). The GPU 112 (or a graphics processing circuit) may be configured to execute parallel computations (e.g., rendering). The NPU 113 (or a neural processing circuit, or an artificial intelligence (AI) chip) may be configured to execute computations (e.g., a convolution computation) for an artificial intelligence model. The ISP 114 (or an image signal processing circuit) may be configured to process a raw image obtained through the image sensor 150 in a format suitable for an element in the electronic apparatus 100 or an element of the processor 110. The display controller 115 (or a display control circuit, or a display processing unit (DPU)) may be configured to process an image obtained from the CPU 111, the GPU 112, the ISP 114, or the memory 120 (e.g., volatile memory 121) in format suitable for the display 140. The memory controller 116 (or a memory control circuit) may be configured to control reading of data from the volatile memory 121 and writing of data in the volatile memory 121. The storage controller 117 (or a storage control circuit) may be configured to control reading of data from the non-volatile memory 122 and writing of data in the non-volatile memory 122. The CP 118 (a communication processing circuit) may process data obtained from an element of the processor 110 in a format suitable for transmitting to another electronic apparatus through the communication circuit 160, or configured to process data obtained from the another electronic apparatus through the communication circuit 160 in a format suitable for processing an element of the processor 110. For example, the communication circuit 160 may include one or more communication circuits. The sensor interface 119 (or a sensing data processing circuit, a sensor hub) may be configured to process data on a state of the electronic apparatus 100 and/or a state surrounding the electronic apparatus 100 obtained through the sensor 170 in a format suitable for an element of the processor 110.

The memory 120 may include one or more storage media (or one or more storage devices). For example, the memory 120 may include a collection of memories that include one or more storage media. For example, the one or more storage media may include permanent memory (e.g., non-volatile memory 122), such as a hard drive, flash memory, and read-only memory (ROM), semi-permanent memory (e.g., volatile memory 121), such as random access memory (RAM), and storage (or a storage assembly) of any other suitable types, or any combination thereof. The memory 120 may include cache memory which is memory of one or more different types used to temporarily store data for a function (function or feature) of the electronic apparatus 100. As an unlimited example, the cache memory may be included in the processor 110. The memory 120 may be fixedly embedded in the electronic apparatus 100, or may be incorporated onto one or more suitable types of components (e.g., a subscriber identity module (SIM) card and/or a secure digital (SD) card) capable of being repeatedly inserted in the electronic apparatus 100 and removed from the electronic apparatus 100.

For example, the memory 120 may store one or more software applications, such as an operating system (or system) software application, a firmware software application, a driver software application, a plug-in (e.g., add-in, add-on, and/or applet) software application, and/or any other suitable software applications. For example, the one or more software applications may include instructions executable by the processor 110. For example, the memory 120 may store instructions callable by an application programming interface (API). For example, the memory 120 may store instructions in a library.

FIG. 4 is a diagram illustrating an operation for outputting a multi-translation result according to an embodiment of the disclosure.

Referring to embodiment 400 in FIG. 4, the electronic apparatus 100 may include at least one of a voice codec module 10, a signal processing module 20, a voice recognition module 30, and an output module 50.

The voice codec module 10 may be a module that performs an encoding or decoding operation associated with an audio signal. The electronic apparatus 100 may receive the first voice (EN, Hello) from the external device 200. The electronic apparatus 100 may decode the received first voice (EN, Hello) through the voice codec module 10. The electronic apparatus 100 may transmit the decoded first voice (EN, Hello) to the signal processing module 20 and the voice recognition module 30.

The signal processing module 20 may be a module for processing the received signal according to a pre-set method. The signal processing module 20 may perform at least one of filtering, conversion, frequency analysis, and real-time processing. The signal processing module 20 may be a Digital Signal Processing (DSP) module.

The signal processing module 20 may apply a signal processing function to the decoded first voice (EN, Hello). The signal processing module 20 may generate a processed first voice (EN, Hello). The signal processing module 20 may provide the processed first voice (EN, Hello) to a first output module 51.

The voice recognition module 30 may be a module that performs a function of recognizing a user voice. The voice recognition module 30 may be a module that analyzes an audio signal which includes the user voice and generates data (text, image, audio, or the like) corresponding to the user voice. The voice recognition module 30 may be an automatic speech recognition (ASR) module.

The voice recognition module 30 may include a module that performs a translation function based on a pre-set language. The pre-set language may be described as a target language. The voice recognition module 30 may generate a translation result by translating the first voice (EN, Hello) in a pre-set language.

The voice recognition module 30 may generate the first translation result (FR, Bonjour) and the second translation result (ES, Hola) based on the first voice (EN, Hello). The voice recognition module 30 may provide the first translation result (FR, Bonjour) and the second translation result (ES, Hola) to the output module 50.

The output module 50 may include a plurality of modules. The output module 50 may include a plurality of modules according to an output device. The plurality of modules included in the output module may be a module for outputting at least one of an image and an audio.

As an example, the output module 50 may include hardware included in the electronic apparatus 100. The output module 50 may include a display, a speaker, and the like.

As an example, the output module 50 may indicate a module for transmitting data to an external device rather than the electronic apparatus 100. The external device may indicate a device which the user can carry individually, such as, earphones, headphones, a wearable device, and the like.

The output module 50 may include the first output module 51 and a second output module 52. The first output module 51 may be a device for providing a translation result to the second user. The second output module 52 may be a device for providing a translation result to the third user.

The first output module 51 may receive the first voice (EN, Hello) from the signal processing module 20. The first output module 51 may receive the first translation result (FR, Bonjour) from the voice recognition module 30. The first output module 51 may output the first voice (EN, Hello) and the first translation result (FR, Bonjour). The first output module 51 may provide the first voice (EN, Hello) and the first translation result (FR, Bonjour) to the second user.

The second output module 52 may receive the first voice (EN, Hello) from the signal processing module 20. The second output module 52 may receive the second translation result (ES, Hola) from the voice recognition module 30. The second output module 52 may output the first voice (EN, Hello) and the second translation result (ES, Hola) based on a second control signal. The second output module 52 may provide the first voice (EN, Hello) and the second translation result (ES, Hola) to the third user.

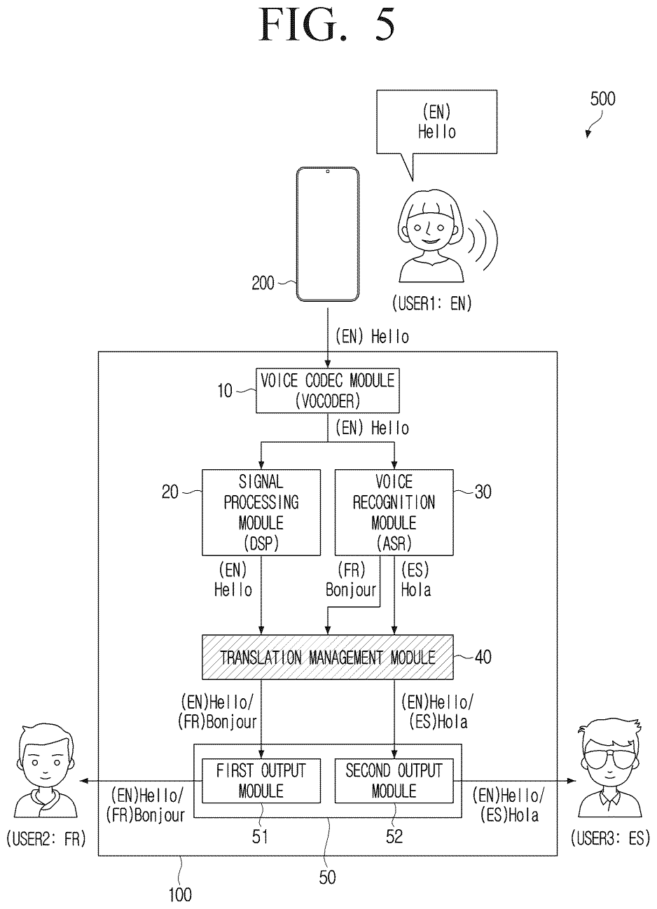

Referring to FIG. 4, the signal processing module 20 and the voice recognition module 30 have been described as transmitting data to the output module 50, respectively. According to another embodiment of the disclosure, the electronic apparatus 100 may additionally include a translation management module 40 for managing an operation for providing the translation result. Description of the translation management module 40 will be described in FIG. 5.

FIG. 5 is a diagram illustrating a translation management module according to an embodiment of the disclosure.

Referring to embodiment 500 in FIG. 5, the electronic apparatus 100 may include at least one of the voice codec module 10, the signal processing module 20, the voice recognition module 30, the translation management module 40, and the output module 50. Descriptions of the voice codec module 10, the signal processing module 20, the voice recognition module 30, and the output module 50 have been described in FIG. 4. Redundant descriptions thereof will be omitted.

The signal processing module 20 may provide the processed first voice (EN, Hello) to the translation management module 40.

The voice recognition module 30 may generate the first translation result (FR, Bonjour) and the first translation result (FR, Bonjour) based on the first voice (EN, Hello). The voice recognition module 30 may provide the first translation result (FR, Bonjour) and the second translation result (ES, Hola) to the translation management module 40.

The translation management module 40 may be a module for managing a method of outputting a translation result. The translation management module 40 may be a module for determining at least one of an area for outputting a translation result, an output device for outputting the translation result, and timing (or time-point) for outputting the translation result.

The translation management module 40 may receive the processed first voice (EN, Hello) from the signal processing module 20. The translation management module 40 may obtain the first translation result (FR, Bonjour) and the second translation result (ES, Hola) from the voice recognition module 30.

The translation management module 40 may obtain the first voice (EN, Hello), the first translation result (FR, Bonjour), and the second translation result (ES, Hola). The translation management module 40 may generate output data for providing to the user based on collected data. Output data may be output through the output module 50.

The translation management module 40 may generate a first control signal for controlling the first output module 51 for the first voice (EN, Hello) and the first translation result (FR, Bonjour) to be provided to the second user together. The first control signal may include a first command for outputting the first voice (EN, Hello), and the first translation result (FR, Bonjour). The translation management module 40 may transmit the first control signal to the first output module 51.

The translation management module 40 may generate a second control signal for controlling the second output module 52 for the first voice (EN, Hello) and the second translation result (ES, Hola) to be provided to the third user together. The second control signal may include a second command for outputting the first voice (EN, Hello), and the second translation result (ES, Hola). The translation management module 40 may transmit the second control signal to the second output module 52.

The translation management module 40 may control the first output module 51 for the first translation result (FR, Bonjour) to be output after the first voice (EN, Hello) is output.

The translation management module 40 may control the second output module 52 for the second translation result (ES, Hola) to be output after the first voice (EN, Hello) is output.

FIG. 6 is a diagram illustrating a receive channel and a transmit channel according to an embodiment of the disclosure.

Referring to embodiment 600 in FIG. 6, the electronic apparatus 100 may include at least one of the voice codec module 10, the signal processing module 20, the voice recognition module 30, and the output module 50. Descriptions associated therewith will be described in FIG. 4.

The signal processing module 20 may include at least one of a receive channel 21 or a transmit channel 22. The receive channel 21 may indicate a channel for processing received signals. The receive channel 21 may be connected to the output module 50 according to a user setting. The receive channel 21 may be connected with the output module 50 according to a method of providing a translation result.

The output module 50 may include a plurality of output modules 51, 52, 53, and 54. The electronic apparatus 100 may determine the first output module 51 corresponding to the second user among the plurality of output modules 51, 52, 53, and 54. The electronic apparatus 100 may determine the second output module 52 corresponding to the third user among the plurality of output modules 51, 52, 53, and 54.

As an example, the output module 50 may include at least one of the display 140, a main speaker, a sub speaker, an audio output terminal, a Bluetooth communication module, and an input and output terminal (USB c-type, high-definition multimedia interface (HDMI)) included in the electronic apparatus 100. The input and output terminal may be described as a USB terminal.

The electronic apparatus 100 may determine a first receive channel (Rx1) corresponding to the first output module 51. The electronic apparatus 100 may determine a second receive channel (Rx2) corresponding to the second output module 52.

As an example, the signal processing module 20 may receive the first voice (EN, Hello) from the voice codec module 10. The voice codec module 10 may be connected to the first receive channel (Rx1) and the second receive channel (Rx2). The signal processing module 20 may transmit the first voice (EN, Hello) received from the voice codec module 10 to the first receive channel (Rx1) and the second receive channel (Rx2).

The signal processing module 20 may receive the first translation result (FR, Bonjour) from the voice recognition module 30. The signal processing module 20 may transmit the first translation result (FR, Bonjour) to the first receive channel (Rx1). The first receive channel (Rx1) may be connected to the first output module 51. The first output module 51 may output the first voice (EN, Hello) and the first translation result (FR, Bonjour) received through the first receive channel (Rx1). The first voice (EN, Hello) and the first translation result (FR, Bonjour) may be provided to the second user through the first output module 51.

The signal processing module 20 may receive the second translation result (ES, Hola) from the voice recognition module 30. The signal processing module 20 may transmit the second translation result (ES, Hola) to the second receive channel (Rx2). The second receive channel (Rx2) may be connected to the second output module 52. The second output module 52 may output the first voice (EN, Hello) and the second translation result (ES, Hola) received through the second receive channel (Rx2). The first voice (EN, Hello) and the second translation result (ES, Hola) may be provided to the second user through the second output module 52.

FIG. 7 is a diagram illustrating an output channel according to an embodiment of the disclosure.

Referring to embodiment 710 in FIG. 7, the electronic apparatus 100 may provide a translation result to the user through various output devices. In an example, the output device may include at least one of the display 140, the main speaker, or the sub speaker included in the electronic apparatus 100. As an example, the output device may indicate an external device that is different from the electronic apparatus 100. The external device may indicate wireless earphones, wired earphones, wireless headphones, wired headphones, and the like.

Referring to embodiment 720 in FIG. 7, the electronic apparatus 100 may provide the user with translation results through various output channels. An output channel may indicate an output device. The electronic apparatus 100 may provide the translation result to the output device through the output module 50.

As an example (case 1), the electronic apparatus 100 may provide the first translation result (FR, Bonjour) to the second user through the speaker of the electronic apparatus 100. The electronic apparatus 100 may provide the second translation result (ES, Hola) to the third user through wireless earphones connected via Bluetooth.

As an example (case 2), the electronic apparatus 100 may provide the first translation result (FR, Bonjour) to the second user through the speaker of the electronic apparatus 100. The electronic apparatus 100 may provide the second translation result (ES, Hola) to the third user through wired earphones connected via the input and output terminal.

As an example (case 3), the electronic apparatus 100 may provide the first translation result (FR, Bonjour) to the second user through wireless earphones connected via Bluetooth. The electronic apparatus 100 may provide the second translation result (ES, Hola) to the third user through the speaker of the electronic apparatus 100.

As an example (case 4), the electronic apparatus 100 may provide the first translation result (FR, Bonjour) to the second user through wireless earphones connected via Bluetooth. The electronic apparatus 100 may provide the second translation result (ES, Hola) to the third user through the wired earphones connected via the input and output terminal.

As an example (case 5), the electronic apparatus 100 may provide the first translation result (FR, Bonjour) to the second user through the wired earphones connected via the input and output terminal. The electronic apparatus 100 may provide the second translation result (ES, Hola) to the third user through the speaker of the electronic apparatus 100.

As an example (case 6), the electronic apparatus 100 may provide the first translation result (FR, Bonjour) to the second user through the wired earphones connected via the input and output terminal. The electronic apparatus 100 may provide the second translation result (ES, Hola) to the third user through the wireless earphones connected via Bluetooth.

As an example (case 5), the electronic apparatus 100 may provide the first translation result (FR, Bonjour) to the second user through a first speaker of the electronic apparatus 100. The electronic apparatus 100 may provide the second translation result (ES, Hola) to the third user through a second speaker of the electronic apparatus 100. The first speaker may be one of a front surface speaker, an upper end speaker, or a main speaker. The second speaker may be one of a back surface speaker, a rear end speaker, or a sub speaker.

FIG. 8 is a diagram illustrating an operation for providing multi-translation in an image according to an embodiment of the disclosure.

Referring to embodiment 800 in FIG. 8, the electronic apparatus 100 may receive the first voice (EN, Hello) from the external device 200. The electronic apparatus 100 may obtain a first text (EN, Hello) corresponding to the first voice (EN, Hello).

The electronic apparatus 100 may obtain the first translation result (FR, Bonjour) and the second translation result (ES, Hola) corresponding to the first voice (EN, Hello).

As an example, the electronic apparatus 100 may obtain the first translation result (FR, Bonjour) and the second translation result (ES, Hola) based on the first voice (EN, Hello).

As an example, the electronic apparatus 100 may obtain the first translation result (FR, Bonjour) and the second translation result (ES, Hola) based on the first text (EN, Hello).

The electronic apparatus 100 may provide a translation service to the second user and the third user. The electronic apparatus 100 may determine the second language corresponding to the second user and the third language corresponding to the third user as target languages associated with the translation service.

The electronic apparatus 100 may output (or provide) the first translation result (FR, Bonjour) and the second translation result (ES, Hola) in an image form. When the translation result is provided in image form, the translation result may be described as an image translation result, image information, image data, a translation image, a translation graphic user interface (UI), and the like. The electronic apparatus 100 may output the first translation result (FR, Bonjour) and the second translation result (ES, Hola) through the display 140.

The electronic apparatus 100 may divide a first area and a second area 140b among an entire area of the display 140. The electronic apparatus 100 may identify the first area 140a corresponding to the second user and the second area 140b corresponding to the third user.

The electronic apparatus 100 may display the first translation result (FR, Bonjour) in the first area 140a, and display the second translation result (ES, Hola) in the second area 140b.

As an example, the electronic apparatus 100 may display the first text (EN, Hello) and the first translation result (FR, Bonjour) in the first area 140a together. The electronic apparatus 100 may display the first text (EN, Hello) and the second translation result (ES, Hola) in the second area 140b together.

As an example, the first area 140a may be a left area of the second area 140b.

According to another embodiment of the disclosure, the electronic apparatus 100 may provide image data to an external device rather than the display 140 of the electronic apparatus 100. The external device may display the image data provided from the electronic apparatus 100 through the display included in the external device.

FIG. 9 is a diagram illustrating an operation for providing multi-translation in audio according to an embodiment of the disclosure.

The first voice (EN, Hello), the first translation result (FR, Bonjour), and the second translation result (ES, Hola) in embodiment 900 of FIG. 9 may correspond to the description of FIG. 8. Redundant descriptions thereof will be omitted.

Unlike FIG. 8, in FIG. 9, the translation result may be provided in audio data form. If the translation result is provided in audio form, the translation result may be described as an audio translation result, audio information, audio data, a translation audio, a translation sound, a translation sound UI, a translated voice, and the like.

The electronic apparatus 100 may identify a first output device 61 corresponding to the second user, and identify a second output device 62 corresponding to the third user.

As an example, the first output device 61 may be a device for outputting the first translation result (FR, Bonjour). The second output device 62 may be a device for outputting the second translation result (ES, Hola).

As an example, the first output device 61 may be one of the speaker, the wired earphones, the wireless earphones, the wired headphones, and the wireless headphones.

As an example, the second output device 62 may be one of the speaker, the wired earphones, the wireless earphones, the wired headphones, and the wireless headphones.

The electronic apparatus 100 may provide (or transmit) the first translation result (FR, Bonjour) to the first output device 61. The electronic apparatus 100 may not output the first translation result (FR, Bonjour) through the display 140. The first output device 61 may output the first translation result (FR, Bonjour). The first output device 61 may output an audio signal for the first translation result (FR, Bonjour).

The electronic apparatus 100 may provide (or transmit) the second translation result (ES, Hola) to the second output device 62. The electronic apparatus 100 may not output the second translation result (ES, Hola) through the display 140. The second output device 62 may output the second translation result (ES, Hola). The second output device 62 may output an audio signal for the second translation result (ES, Hola).

If the output device is a device that outputs audio signals, the output device may be described as an audio output device, an audio playback device, a sound output device, a sound playback device, and the like.

In FIGS. 9 to 11, the first output device 61 and the second output device 62 have been described as wireless earphones. However, the embodiment is not necessarily limited thereto.

FIG. 10 is a diagram illustrating an operation for providing multi-translation in an image and in audio according to an embodiment of the disclosure.

The first voice (EN, Hello), the first translation result (FR, Bonjour), and the second translation result (ES, Hola) of embodiment 1000 in FIG. 10 may correspond to the description of FIG. 8. The first output device 61 and the second output device 62 may correspond to the description of FIG. 9. Redundant descriptions thereof will be omitted.

Unlike FIGS. 8 and 9, in FIG. 10, the translation result may be provided in image data and audio data forms.

The electronic apparatus 100 may display the first translation result (FR, Bonjour) in the first area 140a. The electronic apparatus 100 may provide (or transmit) the first translation result (FR, Bonjour) to the first output device 61. The first output device 61 may output the first translation result (FR, Bonjour).

The electronic apparatus 100 may display the second translation result (ES, Hola) in the second area 140b. The electronic apparatus 100 may provide (or transmit) the second translation result (ES, Hola) to the second output device 62. The second output device 62 may output the second translation result (ES, Hola).

As an example, the electronic apparatus 100 may display the first text (EN, Hello) and the first translation result (FR, Bonjour) in the first area 140a together. The electronic apparatus 100 may display the first text (EN, Hello) and the second translation result (ES, Hola) in the second area 140b together.

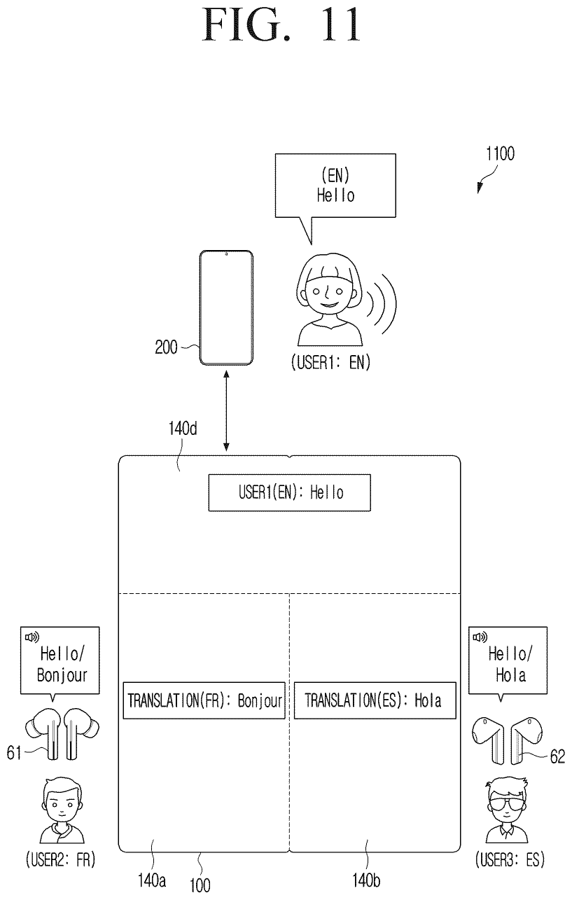

FIG. 11 is a diagram illustrating an operation for displaying a subject of translation and a translation result in separated areas according to an embodiment of the disclosure.

The first voice (EN, Hello), the first translation result (FR, Bonjour), the second translation result (ES, Hola), the first output device 61, and the second output device 62 in embodiment 1100 of FIG. 11 may correspond to FIG. 10. Redundant descriptions thereof will be omitted.

In FIGS. 8 and 10, the first text (EN, Hello) has been described as displayed in a same area as the translation result.

Referring to FIG. 11, the electronic apparatus 100 may identify a fourth area 140d corresponding to the first user, the first area 140a corresponding to the second user, and the second area 140b corresponding to the third user.

The electronic apparatus 100 may display the first text (EN, Hello) in the fourth area 140d. The electronic apparatus 100 may display the first translation result (FR, Bonjour) in the first area 140a. The electronic apparatus 100 may display the second translation result (ES, Hola) in the second area 140b.

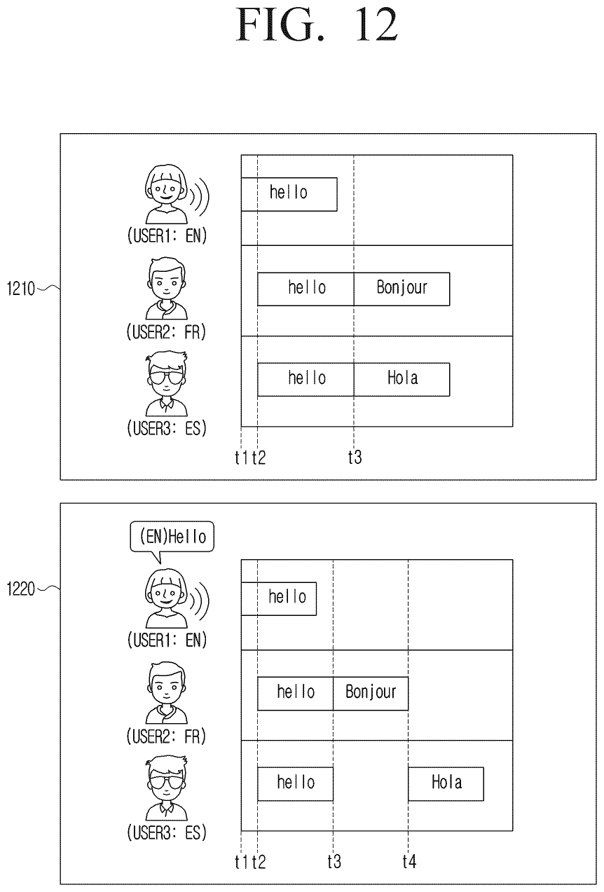

FIG. 12 is a diagram illustrating time-points for outputting an original voice and a translated voice according to an embodiment of the disclosure.

The first voice (EN, Hello), the first translation result (FR, Bonjour), and the second translation result (ES, Hola) in embodiment 1210 of FIG. 12 may correspond to FIGS. 8 to 11. Redundant descriptions thereof will be omitted.

The translation result may be provided in audio data form. The audio data may be provided in voice data form. The first translation result (FR, Bonjour) may include the second voice (FR, Bonjour). The second translation result (ES, Hola) may include the third voice (ES, Hola).

The electronic apparatus 100 may provide the second voice (FR, Bonjour) to the second user as the translation result. The electronic apparatus 100 may provide the third voice (ES, Hola) to the third user as the translation result.

It may be assumed that the first user uttered the first voice (EN, Hello) at a first time-point (t1). The external device 200 may receive the first voice (EN, Hello) of the first user. The external device 200 may transmit the first voice (EN, Hello) to the electronic apparatus 100.

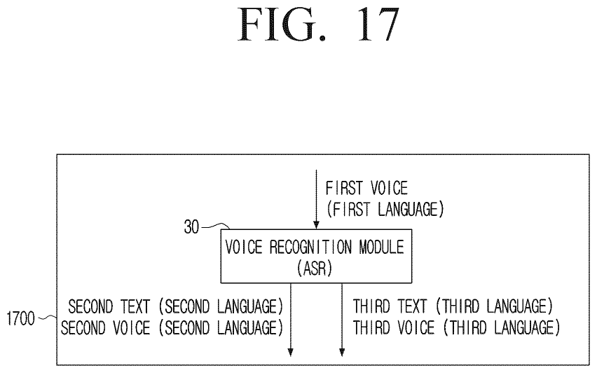

The electronic apparatus 100 may receive the first voice (EN, Hello) from the external device 200. The electronic apparatus 100 may obtain the second voice (FR, Bonjour) corresponding to the first voice (EN, Hello). The electronic apparatus 100 may obtain the third voice (ES, Hola) corresponding to the first voice (EN, Hello). Detailed descriptions associated therewith will be described in FIGS. 17 and 18.

The electronic apparatus 100 may output the first voice (EN, Hello) at a second time-point (t2). The second time-point (t2) may be slower than the first time-point (t1). This is because it takes physical time for the first voice (EN, Hello) to be transferred from the external device 200 to the electronic apparatus 100.

The electronic apparatus 100 may output the second voice (FR, Bonjour) and the third voice (ES, Hola) at a third time-point (t3) after all of the first voice (EN, Hello) is output. The electronic apparatus 100 may control for the first voice (EN, Hello) and the translation result to not be output at the same time-point.

In embodiment 1210 of FIG. 12, the electronic apparatus 100 may output the second voice (FR, Bonjour) and the third voice (ES, Hola) at the same time-point (t3).

Embodiment 1210 in FIG. 12 describes of outputting the second voice (FR, Bonjour) at the third time-point (t3) unlike embodiment 1210 of FIG. 12, and outputting the third voice (ES, Hola) at a fourth time-point (t4). The fourth time-point (t4) may be a time-point later than the third time-point (t3). The fourth time-point (t4) may be a time-point after all of the second voice (FR, Bonjour) is output. The electronic apparatus 100 may output the third voice (ES, Hola) after the second voice (FR, Bonjour) is output.

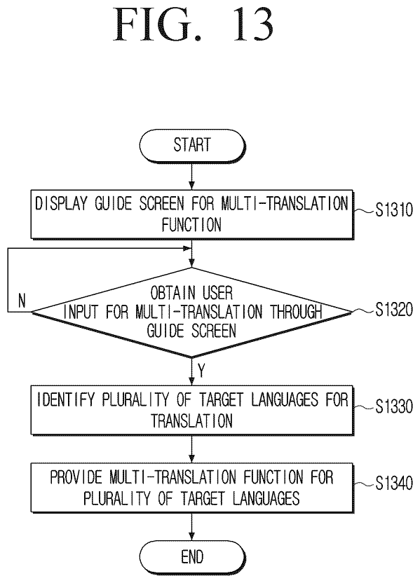

FIG. 13 is a diagram illustrating a basic operation of multi-translation according to an embodiment of the disclosure.

Referring to FIG. 13, the electronic apparatus 100 may display a guide screen for a multi-translation function at operation S1310. The electronic apparatus 100 may obtain a user input through the guide screen.

The electronic apparatus 100 may identify whether a user input for multi-translation is received through the guide screen at operation S1320. If the user input for multi-translation is received through the guide screen at operation S1320-Y, the electronic apparatus 100 may identify a plurality of target languages for translation at operation S1330.

As an example, the electronic apparatus 100 may identify the plurality of target languages by selection of the user.

As an example, the electronic apparatus 100 may identify the plurality of target languages from a periphery device that is currently connectable to the electronic apparatus 100. The periphery device may store language information about the user of the periphery device. The periphery device may transmit language information to the electronic apparatus 100 in response to a request of the electronic apparatus 100. The electronic apparatus 100 may identify a language corresponding to the user based on the language information received from the periphery device.

The electronic apparatus 100 may provide multi-translation function for a plurality of target languages at operation S1340. The electronic apparatus 100 may generate translation results for each of the plurality of target languages with respect to the input voices.

As an example, the plurality of target languages may include the second language and the third language. The electronic apparatus 100 may translate the first text (EN, Hello) in the first language to the second text (FR, Bonjour) in the second language. The electronic apparatus 100 may translate the first text (EN, Hello) in the first language to the third text (ES, Hola) in the third language.

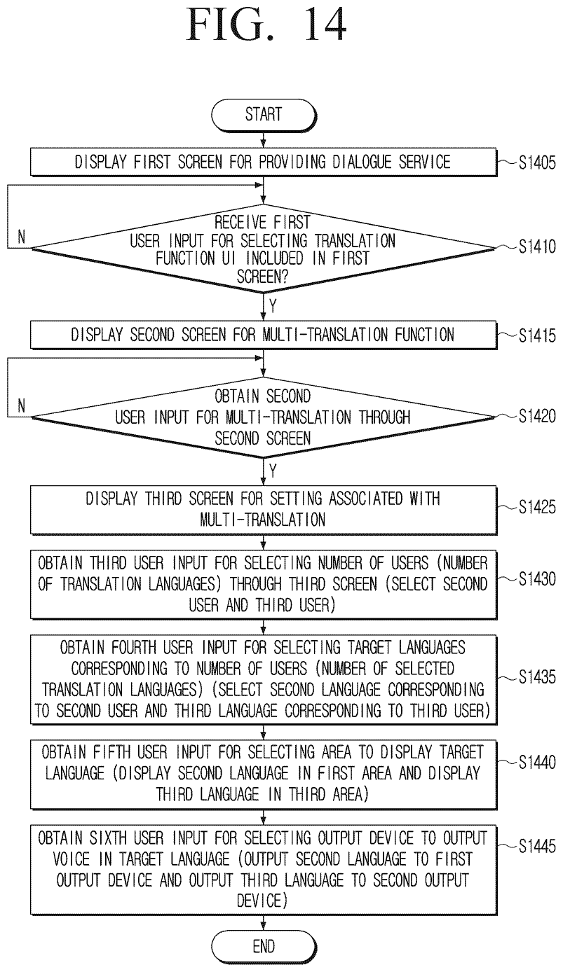

FIG. 14 is a diagram illustrating an operation for obtaining a setting of multi-translation according to an embodiment of the disclosure.

Referring to FIG. 14, the electronic apparatus 100 may display a first screen for providing the dialogue service at operation S1405. The dialogue service may include a multi-user dialogue service. The dialogue service may indicate a service through which a plurality of users can dialogue. As an example, the dialogue service may include a voice call, a video call, an on-line conference, and the like. The service may be described as a function.

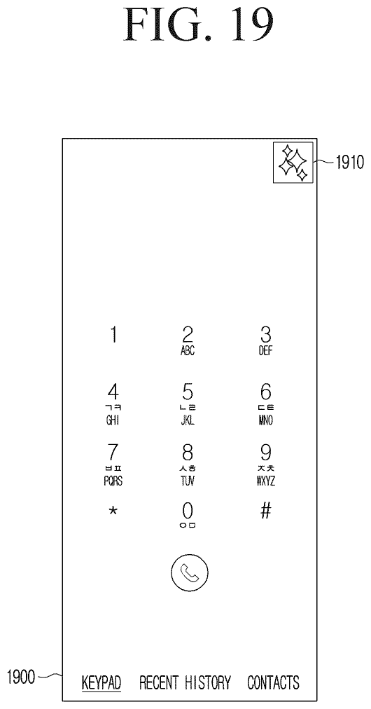

The first screen may include a translation function UI. The first screen will be described in FIG. 19. The electronic apparatus 100 may identify whether a first user input for selecting the translation function UI included in the first screen is received at operation S1410.

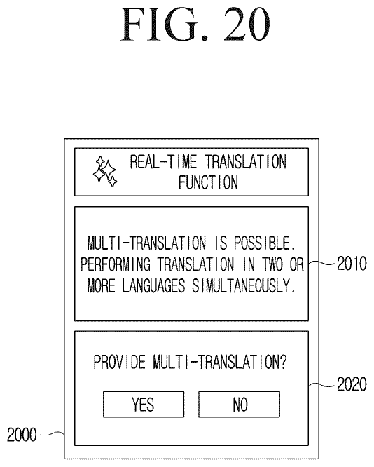

When the first user input is received at operation S1410-Y, the electronic apparatus 100 may display a second screen for the multi-translation function at operation S1415. The second screen may be described in FIG. 20.

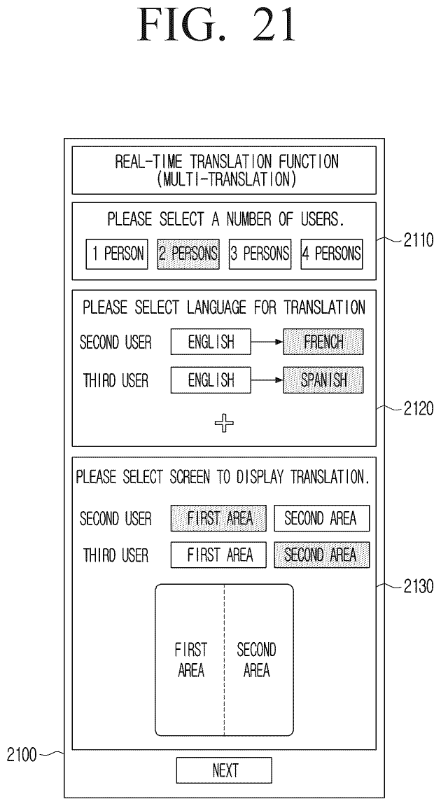

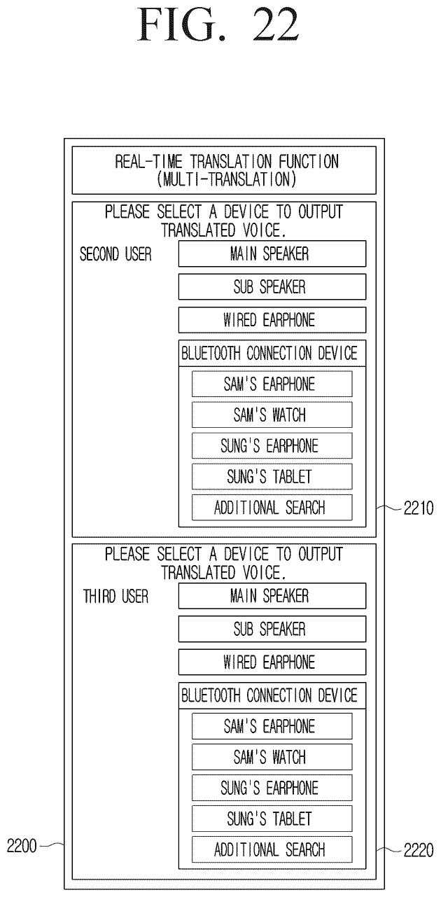

The electronic apparatus 100 may identify whether a second user input for multi-translation is obtained through the second screen at operation S1420. When the second user input is obtained at operation S1420-Y, the electronic apparatus 100 may display a third screen for setting associated with the multi-translation at operation S1425. The third screen may be described in FIGS. 21 and 22.

The electronic apparatus 100 may obtain a third user input for selecting a number of users for multi-translation (or number of translation languages) through the third screen at operation S1430. As an example, the third user input may include a user input for selecting the second user and the third user.

The electronic apparatus 100 may obtain a fourth user input for selecting target languages corresponding to the number of users (or number of selected translation languages) at operation S1435. The target language may indicate a translation language for translation. As an example, the fourth user input may include the second language corresponding to the second user and the third language corresponding to the third user.

The electronic apparatus 100 may obtain a fifth user input for selecting an area to display the target language at operation S1440. The electronic apparatus 100 may divide the entire area of the display 140 according to the number of users. The electronic apparatus 100 may identify how to display the translation result among a plurality of divided areas. As an example, the electronic apparatus 100 may identify the first area to display the translation result in the second language and the second area to display the translation result in the third language based on a fifth user input.

The electronic apparatus 100 may obtain a sixth user input for selecting an output device to output a voice in the target language at operation S1445. The output device may be a device that outputs audio data. The electronic apparatus 100 may determine an output device for outputting audio data that includes a voice in the target language based on the sixth user input. As an example, the sixth user input may include a user input for outputting the translation result in the second language to the first output device, and outputting the translation result in the third language to the second output device.

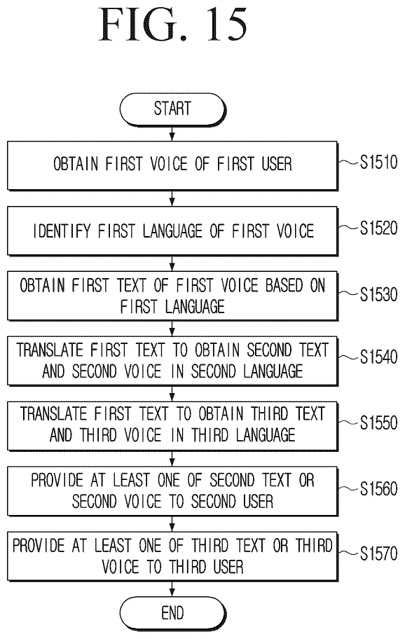

FIG. 15 is a diagram illustrating an operation for obtaining a multi-translation result according to an embodiment of the disclosure.

Referring to FIG. 15, the first user, the second user, and the third user may use the dialogue service through the electronic apparatus 100. The first user may use the external device 200, and the second user and the third user may use the electronic apparatus 100. It may be assumed that the second user uses the second language, and the third user uses the third language.

The electronic apparatus 100 may obtain the first voice of the first user at operation S1510. The first user may be the user of the external device 200. The external device 200 may transmit the first voice of the first user to the electronic apparatus 100. The electronic apparatus 100 may receive the first voice from the external device 200.

The electronic apparatus 100 may identify the language of the first voice. The electronic apparatus 100 may identify the language of the first voice as the first language at operation S1520.

As an example, the electronic apparatus 100 may analyze the language of the first voice. The electronic apparatus 100 may identify the language of the first voice based on a pre-set language analysis database. The identified language may be described as the first language.

As an example, the electronic apparatus 100 may obtain the language of the first voice by user selection. The user who selects the language may be one of the first user, the second user, or the third user.

The electronic apparatus 100 may obtain the first text of the first voice based on the first language at operation S1530. The electronic apparatus 100 may obtain the first text corresponding to the first voice through the voice recognition module 30.

The electronic apparatus 100 may translate the first text to obtain the second text and the second voice in the second language at operation S1540.

The electronic apparatus 100 may translate the first text to obtain the third text and the third voice in the third language at operation S1550.

The electronic apparatus 100 may provide at least one of the second text or the second voice to the second user at operation S1560.

The electronic apparatus 100 may provide at least one of the third text or the third voice to the third user at operation S1570.

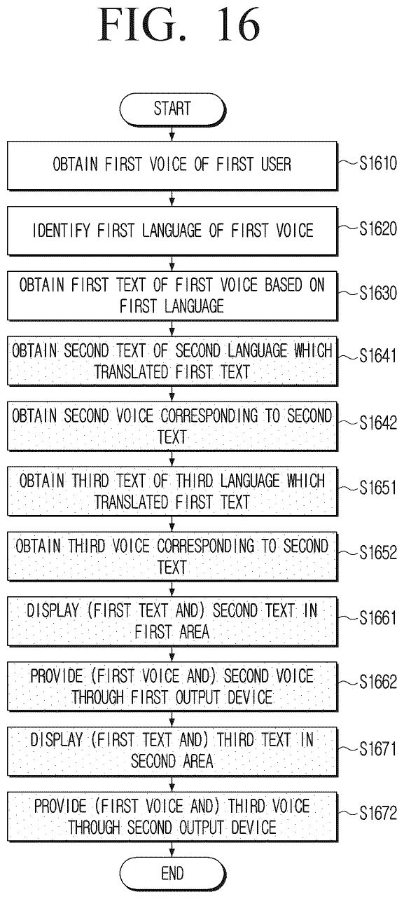

FIG. 16 is a diagram illustrating an operation for providing a multi-translation result according to an embodiment of the disclosure.

Operations S1610, S1620, and S1630 in FIG. 16 may correspond to operations S1510, S1520, and S1530 in FIG. 15. Redundant descriptions thereof will be omitted.

Referring to FIG. 16, the electronic apparatus 100 may obtain the second text in the second language which translated the first text at operation S1641. The electronic apparatus 100 may obtain the second text corresponding to the first text through the voice recognition module 30. The electronic apparatus 100 may obtain the second voice corresponding to the second text at operation S1642. The second text and the second voice may be generated based on the second language.

The electronic apparatus 100 may obtain the third text in the third language which translated the first text at operation S1651. The electronic apparatus 100 may obtain the third text corresponding to the first text through the voice recognition module 30. The electronic apparatus 100 may obtain the third voice corresponding to the third text at operation S1652. The third text and the third voice may be generated based on the third language.

The electronic apparatus 100 may display the second text in the first area at operation S1661. The first area may be an area determined to provide the translation result to the second user. As an example, the electronic apparatus 100 may display the first text and the second text in the first area.

The electronic apparatus 100 may provide the second voice to the second user through the first output device at operation S1662. As an example, the electronic apparatus 100 may provide the first voice and the second voice to the second user through the first output device.

The electronic apparatus 100 may display the third text in the second area at operation S1671. The second area may be an area determined to provide the translation result to the third user. As an example, the electronic apparatus 100 may display the first text and the third text in the second area.

The electronic apparatus 100 may provide the third voice to the third user through the second output device at operation S1672. As an example, the electronic apparatus 100 may provide the first voice and the third voice to the third user through the second output device.

FIG. 17 is a diagram illustrating a voice recognition module according to an embodiment of the disclosure.

Referring to embodiment 1700 in FIG. 17, the electronic apparatus 100 may include the voice recognition module 30. The voice recognition module 30 may be a module for obtaining a text corresponding to a voice, and outputting a translation result.

The voice recognition module 30 may receive the first voice (first language). The voice recognition module 30 may obtain the first text corresponding to the first voice.

The voice recognition module 30 may translate the first text in the first language to the second text in the second language. The voice recognition module 30 may obtain the second voice corresponding to the second text in the second language.

The voice recognition module 30 may translate the first text in the first language to the third text in the third language. The voice recognition module 30 may obtain the third voice corresponding to the third text in the third language.

Referring to FIG. 17, the voice recognition module 30 has been described as performing all of a function for recognizing a text included in a voice, a translation function for the text, and a function for generating a voice corresponding to the translated text. However, the above described respective functions may be performed by different modules from one another. Descriptions associated therewith will be described in FIG. 18.

FIG. 18 is a diagram illustrating an operation for obtaining a translation result according to an embodiment of the disclosure.

Referring to FIG. 18, the electronic apparatus 100 may include at least one of the voice recognition module 30, a translation module 31, or a voice generation module 32.

Referring to embodiment 1810 in FIG. 18, the electronic apparatus 100 may convert the first voice to the first text through the voice recognition module 30.

The electronic apparatus 100 may convert the first text in the first language to the second text in the second language through the translation module 31. The electronic apparatus 100 may convert the first text in the first language to the third text in the third language through the translation module 31.

The electronic apparatus 100 may convert the second text in the second language to the second voice in the second language through the voice generation module 32. The electronic apparatus 100 may convert the third text in the third language to the third voice in the third language through the voice generation module 32.

As an example, the voice generation module 32 may be a Text-to-Speech (TTS) module.

Referring to embodiment 1820 in FIG. 18, the electronic apparatus 100 may obtain the second voice in the second language based on the first voice in the first language and the second text in the second language. The electronic apparatus 100 may obtain the second voice through the voice generation module 32. Unlike embodiment 1810 in FIG. 18, the electronic apparatus 100 may obtain the second voice taking into consideration the first voice additionally in addition to the second text.

The electronic apparatus 100 may obtain the third voice in the third language based on the first voice in the first language and the third text in the third language. The electronic apparatus 100 may obtain the third voice through the voice generation module 32. Unlike embodiment 1810 in FIG. 18, the electronic apparatus 100 may obtain the third voice taking into consideration the first voice additionally in addition to the third text.

The reason for taking into consideration the first voice is for the second voice and the third voice to also sound like the voice of the first user. The second voice and the third voice may ultimately indicate the translation result of the first voice. Accordingly, the first voice may be used for the second voice and the third voice to sound like the voice of the first user.

The voice generation module 32 in embodiment 1820 of FIG. 18 may be an artificial intelligence (AI) model that uses the first voice and the second text as input data and outputs the second voice.

FIG. 19 is a diagram illustrating a screen showing a translation function according to an embodiment of the disclosure.

Referring to FIG. 19, the electronic apparatus 100 may display a screen 1900 for providing the dialogue service. As an example, the screen 1900 may be a screen associated with a call.

The screen 1900 may include a translation function UI 1910. The translation function may indicate a function for providing real-time translation to the user. When a user input selecting the translation function UI 1910 is received, the translation function UI 1910 may display a screen 2000 of FIG. 20.

FIG. 20 is a diagram illustrating a screen guiding multi-translation according to an embodiment of the disclosure.

Referring to FIG. 20, the electronic apparatus 100 may display the screen 2000 associated with the real-time translation function. The screen 2000 may include at least one of a UI 2010 indicating that multi-translation is possible, and a UI 2020 for receiving a user input associated with multi-translation.

The UI 2010 may include information indicating that multi-translation is a translation that provides two or more translation results.

When a user input for performing multi-translation is received through the UI 2020, the electronic apparatus 100 may display the screen of FIG. 21 or 22.

FIG. 21 is a diagram illustrating a screen for setting of multi-translation according to an embodiment of the disclosure.

Referring to FIG. 21, the electronic apparatus 100 may display a screen 2100 for setting associated with multi-translation.

The screen 2100 may include at least one of a UI 2110 for selecting a number of users, a UI 2120 for selecting the translation language, and a UI 2130 for displaying the translation results.

When a user input for selecting a number of users is received through the UI 2110, the electronic apparatus 100 may display the UI 2120 for selecting the translation language based on the number of users. The electronic apparatus 100 may receive a user input for obtaining the target language of the subject of translation through the UI 2120.

As an example, a language of an input voice (English in FIG. 21) may be selected by the user.

As an example, the language of the input voice may be automatically determined.

When the user input for selecting the number of users is received through the UI 2110, the electronic apparatus 100 may display the UI 2130 for selecting the area to display the translation results based on the number of users.

The electronic apparatus 100 may receive a user input for determining which area the result of the translation language selected from the UI 2120 is to be displayed through the UI 2130. As an example, the electronic apparatus 100 may determine that the translation result provided to the second user is to be displayed in the first area based on the user input received from the UI 2130. The electronic apparatus 100 may determine that the translation result provided to the third user is to be displayed in the second area based on the user input received from the UI 2130.

FIG. 22 is a diagram illustrating a screen for selecting output devices according to an embodiment of the disclosure.

Referring to FIG. 22, the electronic apparatus 100 may display a screen 2200 for selecting output devices to output the translation results.

As an example, the screen 2100 of FIG. 21 and the screen 2200 of FIG. 22 may be the same screen.

When the user input for selecting the number of users is received through the UI 2110 of FIG. 21, the electronic apparatus 100 may display the UIs 2210 and 2220 for selecting an output device to output the translation result based on the number of users.

The UI 2210 may be a UI for selecting an output device corresponding to the second user. The UI 2220 may be UI for selecting an output device corresponding to the third user.

The UIs 2210 and 2220 may include information for selecting at least one device capable of outputting a voice.

As an example, the UIs 2210 and 2220 may include information for selecting an external device connectable to the electronic apparatus 100. The electronic apparatus 100 may obtain a list indicating external devices that are connectable at the current state.

As an example, the electronic apparatus 100 may provide a list of external devices that are connectable via Bluetooth through the screen 2200.

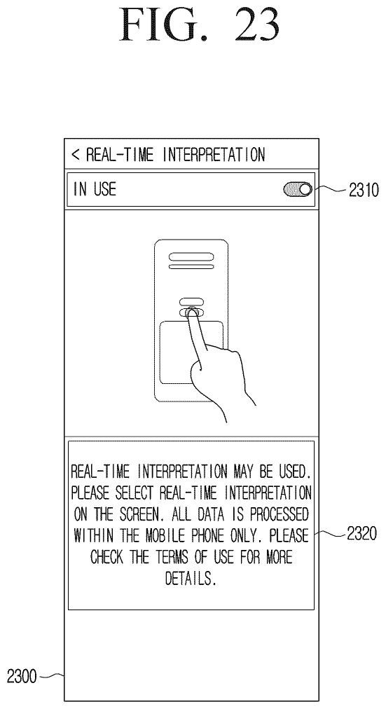

FIG. 23 is a diagram illustrating a screen for guiding real-time interpretation according to an embodiment of the disclosure.

Referring to FIG. 23, a screen 2300 indicating a function associated with real-time interpretation may be displayed.

The screen 2300 may include at least one of a UI 2310 for determining whether to perform the function associated with real-time interpretation, and a UI 2320 for describing the real-time interpretation function.

When the real-time interpretation function is selected through the UI 2310, the electronic apparatus 100 may perform the real-time interpretation function with respect to the voice of the other party.

The UI 2320 may include at least one of information indicating a real-time interpretation service, information guiding to select the UI 2310, information indicating a data processing method, and rules associated with the real-time interpretation service.

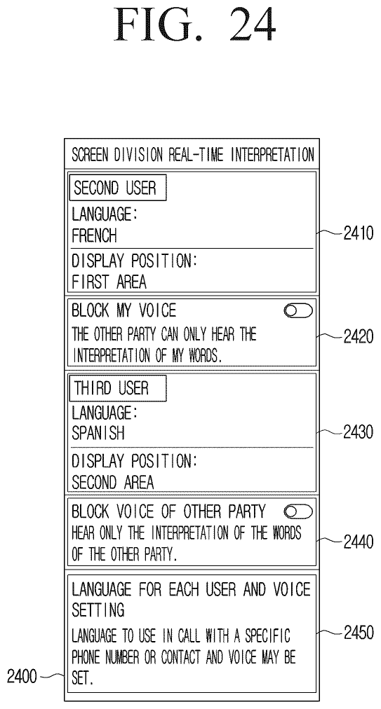

FIG. 24 is a diagram illustrating a setting screen associated with real-time interpretation according to an embodiment of the disclosure.

Referring to FIG. 24, the electronic apparatus 100 may display a screen 2400 for setting associated with multi-translation. The screen 2400 may include a UI for setting information corresponding to the selected user.

The screen 2400 may include at least one of a UI 2410 for determining setting information corresponding to the second user, a UI 2420 for blocking an original sound received from the electronic apparatus 100, a UI 2430 for determining setting information corresponding to the third user, a UI 2440 for blocking the original sound transmitted from the external device 200, and a UI 2450 for setting a language for each user.

The UI 2410 may be a UI for selecting the language of the second user and a position to display the translation result provided to the second user.

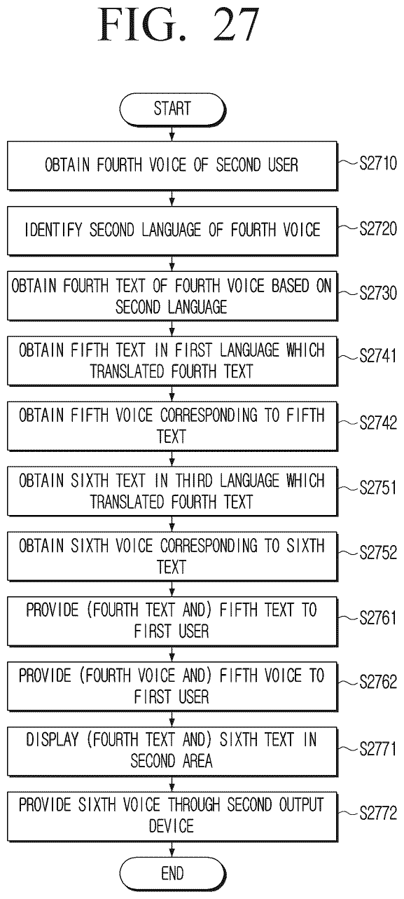

The UI 2420 may be a UI for setting so that when the voice of the second user (or third user) is provided to the first user, the original voice is blocked and only the translated voice is provided. As an example, when a block function is set through the UI 2420, the electronic apparatus 100 may provide only the translated voice (fifth voice in FIG. 27) to the external device 200.

The UI 2430 may be a UI for selecting the language of the third user and a position to display the translation result provided to the third user.

The UI 2440 may be a UI for setting so that when the voice of the first user is provided through the electronic apparatus 100, the original voice is blocked and only the translated voice is provided. As an example, when the block function is set through the UI 2440, the electronic apparatus 100 may have only the translated voice (second voice and third voice in FIG. 16) output.

The UI 2450 may be a UI for setting the user language to a pre-stored phone number. When the language corresponding to the phone number is set, the electronic apparatus 100 may provide the translation result without having to set the language separately. Through the UI 2450, the electronic apparatus 100 may store the language corresponding to the phone number of the second user as the second language. Through UI 2450, the electronic apparatus 100 may store the language corresponding to the phone number of the third user as the third language.

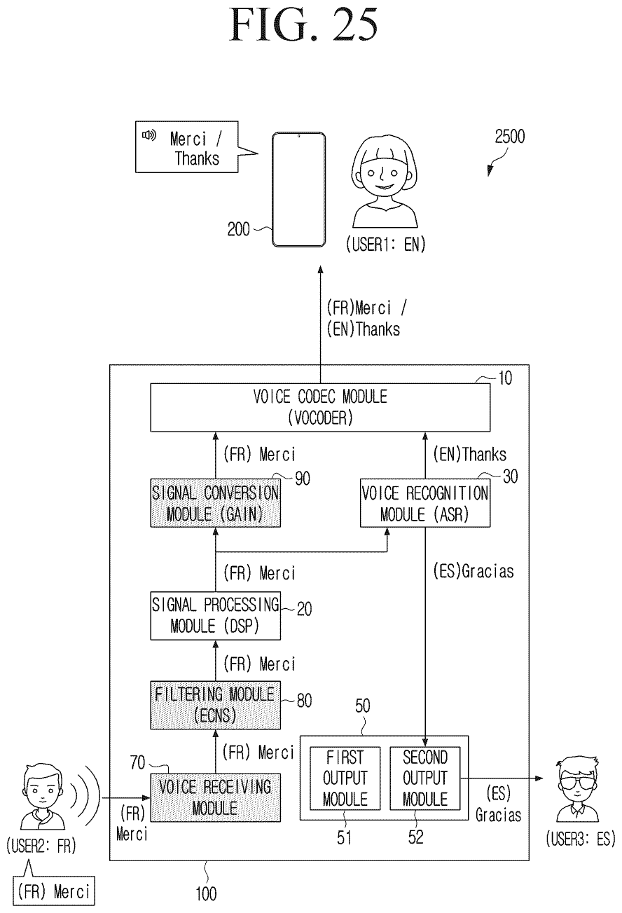

FIG. 25 is a diagram illustrating an operation of the electronic apparatus 100 providing multi-translation by receiving voice directly according to an embodiment of the disclosure.

Referring to embodiment 2500 in FIG. 25, the electronic apparatus 100 may include at least one of the voice codec module 10, the signal processing module 20, the voice recognition module 30, the output module 50, a voice receiving module 70, a filtering module 80, and a signal conversion module 90.

The electronic apparatus 100 may receive a user voice through the voice receiving module 70.

As an example, the voice receiving module 70 may be module for receiving a user voice obtained through a microphone included in the electronic apparatus 100.

As an example, the voice receiving module 70 may be a module for receiving a user voice received from an external device through a communication interface.

The electronic apparatus 100 may receive a fourth voice (FR, Merci) of the second user through the voice receiving module 70. The voice receiving module 70 may transmit the fourth voice (FR, Merci) to the filtering module 80.

The filtering module 80 may be a module for filtering at least one of an echo or a noise. The filtering module 80 may be an Echo Cancellation and Noise Suppression (ECNS) module. The filtering module 80 may remove the echo indicating sound reflected from the received fourth voice (FR, Merci). The filtering module 80 may remove the noise indicating a background noise from the fourth voice (FR, Merci).

The filtering module 80 may transmit the filtered fourth voice (FR, Merci) to the signal processing module 20. The signal processing module 20 may perform signal processing of the fourth voice (FR, Merci).

The signal processing module 20 may be a module for processing the received signal according to a pre-set method. The signal processing module 20 may perform at least one of filtering, conversion, frequency analysis, and real-time processing. The signal processing module 20 may be a digital signal processing (DSP) module.

The signal processing module 20 may apply the signal processing function to the filtered fourth voice (FR, Merci). The signal processing module 20 may generate a processed fourth voice (FR, Merci). The signal processing module 20 may transmit the processed fourth voice (FR, Merci) to the signal conversion module 90.

The signal conversion module 90 may be a module for adjusting a size of a signal. The signal conversion module 90 may perform at least one of signal amplification, signal attenuation, and change of dynamic range. The signal conversion module 90 may generate a converted fourth voice (FR, Merci) by adjusting the size of the signal with respect to the processed fourth voice (FR, Merci). The signal conversion module 90 may transmit the converted fourth voice (FR, Merci) to the voice codec module 10.

The voice codec module 10 may perform an encoding operation with respect to the converted fourth voice (FR, Merci). The voice codec module 10 may transmit an encoded fourth voice (FR, Merci) to the external device 200.

The external device 200 may receive the encoded fourth voice (FR, Merci). The external device 200 may decode the encoded fourth voice (FR, Merci). The external device 200 may output a decoded fourth voice (FR, Merci).

The signal processing module 20 may transmit the processed fourth voice (FR, Merci) to the voice recognition module 30. The voice recognition module 30 may analyze the processed fourth voice (FR, Merci) and obtain a fourth text corresponding to the fourth voice (FR, Merci).

The voice recognition module 30 may perform the translation function in the first language of the first user based on the fourth text. The voice recognition module 30 may generate a third translation result (EN, Thanks) of the first language based on the fourth text. The voice recognition module 30 may transmit the third translation result (EN, Thanks) to the voice codec module 10. The voice codec module 10 may encode the third translation result (EN, Thanks). The voice codec module 10 may transmit the encoded third translation result (EN, Thanks) to the external device 200.

The external device 200 may decode the encoded third translation result (EN, Thanks). The external device 200 may output the decoded third translation result (EN, Thanks).

The voice recognition module 30 may perform the translation function in the third language of the third user based on the fourth text. The voice recognition module 30 may generate a fourth translation result (ES, Gracias) in the third language based on the fourth text. The voice recognition module 30 may transmit the fourth translation result (ES, Gracias) to the second output module 52. The second output module 52 may provide the fourth translation result (ES, Gracias) to the third user.

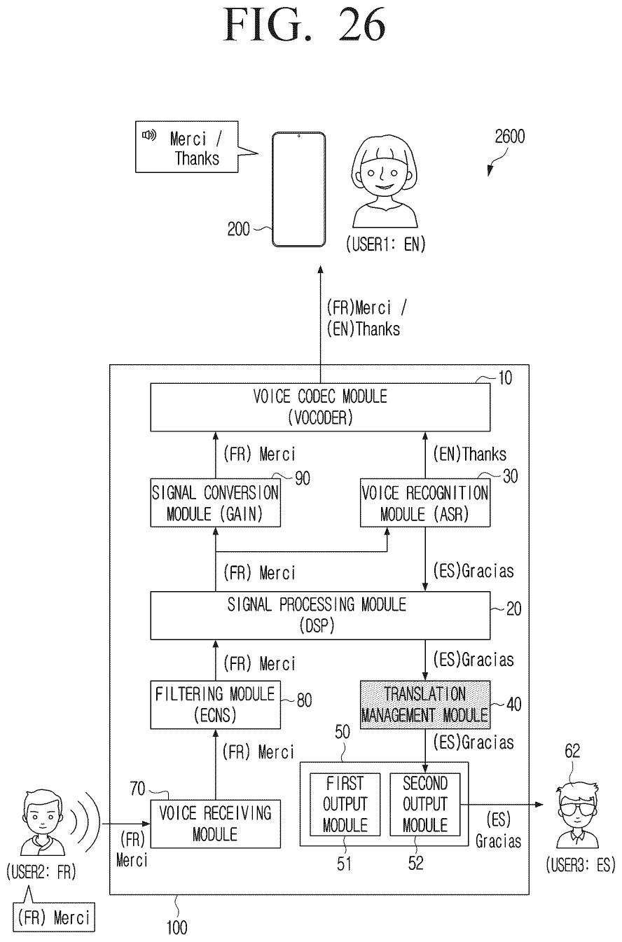

FIG. 26 is a diagram illustrating a translation management module according to an embodiment of the disclosure.

The voice codec module 10, the signal processing module 20, the voice recognition module 30, the output module 50, the voice receiving module 70, the filtering module 80, and the signal conversion module 90 in FIG. 26 may correspond to that in FIG. 25. The fourth voice (FR, Merci), the third translation result (EN, Thanks), and the fourth translation result (ES, Gracias) may correspond to that in FIG. 25. Redundant descriptions thereof will be omitted.

Referring to embodiment 2600 in FIG. 26, the electronic apparatus 100 may additionally include the translation management module 40.

The translation management module 40 may be a module for determining at least one of an area for outputting the translation result, an output device for outputting the translation result, and timing (or time-point) for outputting the translation result.

The signal processing module 20 may transmit the fourth translation result (ES, Gracias) to the translation management module 40. The translation management module 40 may control the second output module 52 to provide the fourth translation result (ES, Gracias) to the third user.

FIG. 27 is a diagram illustrating an operation of the electronic apparatus 100 providing multi-translation based on a received voice according to an embodiment of the disclosure.

Referring to FIG. 27, the electronic apparatus 100 may obtain the fourth voice of the second user at operation S2710. The electronic apparatus 100 may identify the language of the fourth voice. The electronic apparatus 100 may identify the language of the fourth voice as the second language at operation S2720.

The electronic apparatus 100 may obtain the fourth text of the fourth voice based on the second language at operation S2730. The electronic apparatus 100 may obtain a fifth text in the first language which translated the fourth text at operation S2741. The electronic apparatus 100 may obtain a fifth voice corresponding to the fifth text at operation S2742.

The electronic apparatus 100 may obtain a sixth text in the third language which translated the fourth text at operation S2751. The electronic apparatus 100 may obtain a sixth voice corresponding to the sixth text at operation S2752.

The electronic apparatus 100 may provide the fifth text to the first user at operation S2761. The electronic apparatus 100 may provide the fifth text to the external device 200. As an example, the electronic apparatus 100 may provide the first user with the fourth text and the fifth text together.

The electronic apparatus 100 may provide the fifth voice to the first user operation S2762. The electronic apparatus 100 may provide the fifth voice to the external device 200. As an example, the electronic apparatus 100 may provide the first user with the fourth voice and the fifth voice together.

The electronic apparatus 100 may display the sixth text in the second area at operation S2771. The electronic apparatus 100 may display the sixth text in the second area of the display 140. The second area may be an area determined to provide the translation result to the third user. As an example, the electronic apparatus 100 may display the fourth text and the sixth text in the second area together.

The electronic apparatus 100 may provide the sixth voice to the third user through the second output device at operation S2772. The electronic apparatus 100 may not provide the fourth voice to the third user. This is because the second user and the third user may be in a same space, and there is a high likelihood of the third user directly hearing the fourth voice of the second user. If the fourth voice is output to the third user, the third user may redundantly hear the actual utterance (fourth voice) of the second user and the fourth voice provided through the second output device. Accordingly, the electronic apparatus 100 may exclude the fourth voice and provide only the sixth voice to the third user.

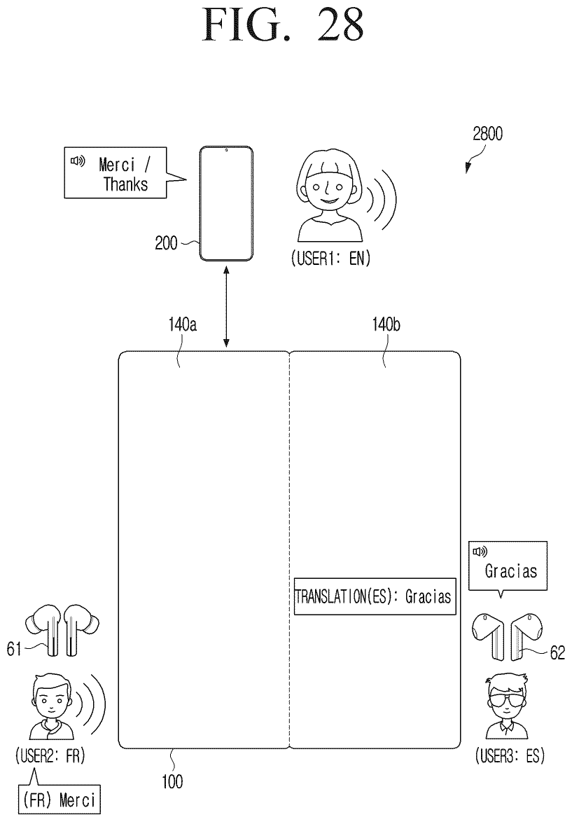

FIG. 28 is a diagram illustrating an operation of the electronic apparatus 100 providing a translation result based on a received voice according to an embodiment of the disclosure.

Referring to embodiment 2800 in FIG. 28, the second user may utter the fourth voice (FR, Merci). The electronic apparatus 100 may receive the fourth voice (FR, Merci) of the second user. The electronic apparatus 100 may obtain the third translation result (EN, Thanks) and the fourth translation result (ES, Gracias) corresponding to the fourth voice (FR, Merci).

The electronic apparatus 100 may transmit the third translation result (EN, Thanks) to the external device 200. The electronic apparatus 100 may provide the fourth translation result (ES, Gracias) to the third user.

As an example, it may be assumed that the second user uses the first output device 61 and the third user uses the second output device 62. The first output device 61 may receive the fourth voice (FR, Merci) of the second user. The first output device 61 may transmit the fourth voice (FR, Merci) to the electronic apparatus 100. The electronic apparatus 100 may obtain the third translation result (EN, Thanks) and the fourth translation result (ES, Gracias) corresponding to the fourth voice (FR, Merci).

The electronic apparatus 100 may transmit the third translation result (EN, Thanks) to the external device 200. The electronic apparatus 100 may transmit the fourth translation result (ES, Gracias) to the second output device 62.

The fourth translation result (ES, Gracias) may be provided to the third user in a form of at least one of image data or audio data.

As an example, the second output device 62 may be a device for outputting audio signals. The electronic apparatus 100 may generate the sixth voice corresponding to the fourth translation result (ES, Gracias). The electronic apparatus 100 may transmit the sixth voice to the second output device 62.

As an example, the electronic apparatus 100 may display the fourth translation result (ES, Gracias) in the second area 140b of the display 140.

As an example, the electronic apparatus 100 may transmit the sixth voice corresponding to the fourth translation result (ES, Gracias) to the second output device 62, and display the sixth text corresponding to the fourth translation result (ES, Gracias) in the second area 140b.

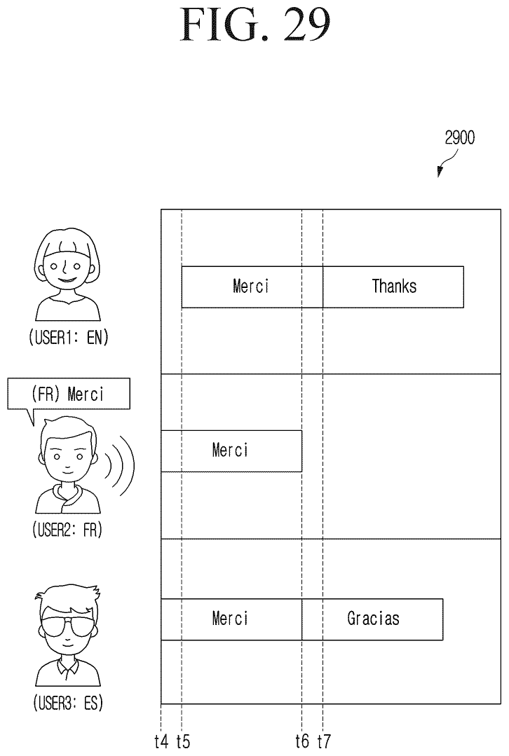

FIG. 29 is a diagram illustrating a time-point for outputting a translation result according to an embodiment of the disclosure.

Referring to embodiment 2900 in FIG. 29, the electronic apparatus 100 may receive the fourth voice (FR, Merci) of the second user at the fourth time-point (t4). The electronic apparatus 100 may transmit the fourth voice (FR, Merci) to the external device 200. The external device 200 may output the received fourth voice (FR, Merci) at a fifth time-point (t5). The fifth time-point (t5) may be slower than the fourth time-point (t4). This is because it takes time for the signal to be transmitted to the external device 200.

The external device 200 may output the third translation result (EN, Thanks) at a time-point (t7) at which all of the fourth voice (FR, Merci) is output.

The electronic apparatus 100 may provide the fourth translation result (ES, Gracias) to the third user at a time-point (t6) at which all of the fourth voice (FR, Merci) is output through the second output device.

FIG. 30 is a diagram illustrating various structures of the electronic apparatus 100 according to an embodiment of the disclosure.

Referring to embodiment 3010 of FIG. 30, the electronic apparatus 100 may be implemented in the first structure. As an example, the electronic apparatus 100 of the first structure may include a display without a folding function. As an example, the electronic apparatus 100 of the first structure may include a display with the folding function in the horizontal direction.

Referring to embodiment 3020 in FIG. 30, the electronic apparatus 100 may be implemented in the second structure. The electronic apparatus 100 of the second structure may include a display that is folded once in the vertical direction. The electronic apparatus 100 of the second structure may include a display that includes one folding line.

Referring to embodiment 3030 in FIG. 30, the electronic apparatus 100 may be implemented in the third structure. The electronic apparatus 100 of the third structure may include a display that is folded twice in the vertical direction. The electronic apparatus 100 of the third structure may include a display that includes two folding lines.

The first structure will be described in FIGS. 31 to 35.

The second structure will be described in FIGS. 8 to 11.

The third structure will be described in FIGS. 36 to 40.

FIG. 31 is a diagram illustrating an operation for providing a translation result in an image through the electronic apparatus 100 of a first structure according to an embodiment of the disclosure.

Referring to FIG. 31, embodiment 3100 may correspond to embodiment 800 in FIG. 8. Redundant descriptions thereof will be omitted. The electronic apparatus 100 in FIG. 8 may include the display of the second structure, and the electronic apparatus 100 in FIG. 31 may include the display of the first structure.

The electronic apparatus 100 may receive the first voice (EN, Hello) of the first user. The electronic apparatus 100 may obtain the first translation result (FR, Bonjour) and the second translation result (ES, Hola) based on the first voice (EN, Hello).

The electronic apparatus 100 may provide the translation result in image form. The electronic apparatus 100 may divide the display 140 into a plurality of areas. The electronic apparatus 100 may determine the first area 140a to display the first translation result (FR, Bonjour) and the second area 140b to display the second translation result (ES, Hola).

As an example, the first area 140a may be an area on top of the second area 140b.

The electronic apparatus 100 may display the first translation result (FR, Bonjour) in the first area 140a. The electronic apparatus 100 may display the second translation result (ES, Hola) in the second area 140b.

As an example, the electronic apparatus 100 may display the first voice (EN, Hello) and the first translation result (FR, Bonjour) in the first area 140a together.

As an example, the electronic apparatus 100 may display the first voice (EN, Hello) and the second translation result (ES, Hola) in the second area 140b together.

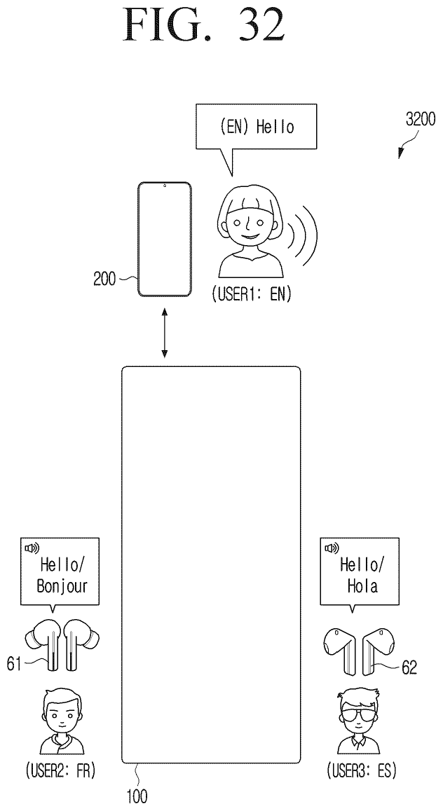

FIG. 32 is a diagram illustrating an operation for providing a translation result in audio through the electronic apparatus 100 of a first structure according to an embodiment of the disclosure.

Embodiment 3200 in FIG. 32 may correspond to embodiment 900 in FIG. 9. Redundant descriptions thereof will be omitted. The electronic apparatus 100 in FIG. 9 may include the display of the second structure, and the electronic apparatus 100 in FIG. 32 may include the display of the first structure.

The electronic apparatus 100 may provide the translation result in audio form only.

The electronic apparatus 100 may transmit an audio signal corresponding to the first translation result (FR, Bonjour) to the first output device 61. The electronic apparatus 100 may transmit an audio signal corresponding to the second translation result (ES, Hola) to the second output device 62.

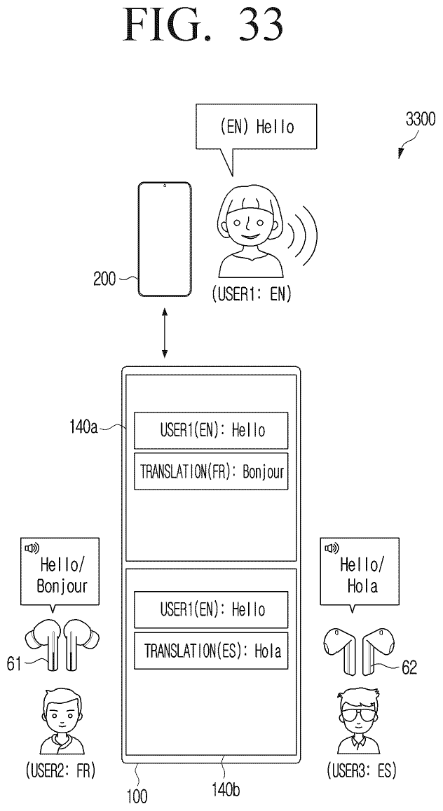

FIG. 33 is a diagram illustrating an operation for providing a translation result in an image and in audio through the electronic apparatus 100 of a first structure according to an embodiment of the disclosure.

Embodiment 3300 in FIG. 33 may correspond to embodiment 1000 in FIG. 10. Redundant descriptions thereof will be omitted. The electronic apparatus in FIG. 10 may include the display of the second structure, and the electronic apparatus 100 in FIG. 33 may include the display of the first structure.

The electronic apparatus 100 may provide the translation result in image form and in audio form.

The electronic apparatus 100 may display the first translation result (FR, Bonjour) in the first area 140a, and transmit the audio signal corresponding to the first translation result (FR, Bonjour) to the first output device 61.

The electronic apparatus 100 may display the second translation result (ES, Hola) in the second area 140b, and transmit the audio signal corresponding to the second translation result (ES, Hola) to the second output device 62.

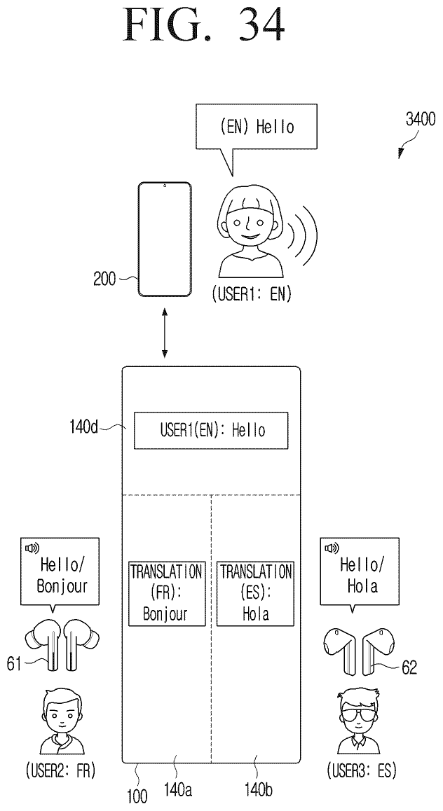

FIG. 34 is a diagram illustrating an operation for providing a translation result in an image and in audio through the electronic apparatus 100 of a first structure according to an embodiment of the disclosure.

Embodiment 3400 in FIG. 34 may correspond to embodiment 1100 in FIG. 11. Redundant descriptions thereof will be omitted. The electronic apparatus 100 in FIG. 11 may include the display of the second structure, and the electronic apparatus 100 in FIG. 34 may include the display of the first structure.

Referring to FIG. 34, the electronic apparatus 100 may display the first translation result (FR, Bonjour) in the first area 140a. The electronic apparatus 100 may display the second translation result (ES, Hola) in the second area 140b. The electronic apparatus 100 may display first voice (EN, Hello) of the first user in the fourth area 140d.

As an example, the first area 140a may be present at a left side of the second area 140b. The fourth area 140d may be present at an upper side of the first area 140a and the second area 140b.

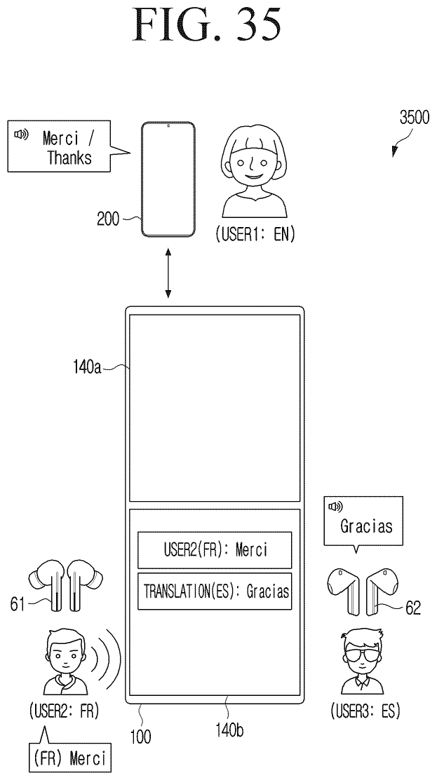

FIG. 35 is a diagram illustrating an operation of the electronic apparatus 100 of a first structure for not outputting a received voice and providing only a translation result according to an embodiment of the disclosure.

Embodiment 3500 in FIG. 35 may correspond to embodiment 2800 in FIG. 28. Redundant descriptions thereof will be omitted. The electronic apparatus 100 in FIG. 28 may include the display of the second structure, and the electronic apparatus 100 in FIG. 35 may include the display of the first structure.

The second user may utter the fourth voice (FR, Merci). The electronic apparatus 100 may receive the fourth voice (FR, Merci) of the second user. The electronic apparatus 100 may obtain the third translation result (EN, Thanks) and the fourth translation result (ES, Gracias) corresponding to the fourth voice (FR, Merci).

The electronic apparatus 100 may display the fourth translation result (ES, Gracias) in the second area 140b while not displaying any information in the first area 140a. The electronic apparatus 100 may transmit an audio signal corresponding to the fourth translation result (ES, Gracias) to the second output device 62.

FIG. 36 is a diagram illustrating an operation for providing a translation result in an image through the electronic apparatus 100 of a third structure according to an embodiment of the disclosure.

Embodiment 3600 in FIG. 36 may correspond to embodiment 800 in FIG. 8 and embodiment 3100 in FIG. 31. Redundant descriptions thereof will be omitted. The electronic apparatus 100 in FIG. 8 may include the display of the second structure, and the electronic apparatus in FIG. 36 may include the display of the third structure. Embodiment 3600 assumes that a fourth user is present additionally. It may be assumed that the fourth user uses a fourth language (Chinese). The electronic apparatus 100 may determine the target languages as the second language (French), the third language (Spanish), and the fourth language (Chinese).

Referring to FIG. 36, the electronic apparatus 100 may obtain the first translation result (FR, Bonjour), the second translation result (ES, Hola), and a fifth translation result (CN, Nihao).

The electronic apparatus 100 may obtain the fifth translation result (CN, Nihao) of the fourth language based on the first voice (EN, Hello).

The electronic apparatus 100 may provide the translation result in image form. The electronic apparatus 100 may determine the first area 140a corresponding to the second user, the second area 140b corresponding to the third user, and a third area 140c corresponding to the fourth user.

As an example, the second area 140b may be present at a left side of the third area 140c. The first area 140a may be present at the left side of the second area 140b.

The electronic apparatus 100 may display the first translation result (FR, Bonjour) in the first area 140a. The electronic apparatus 100 may display the second translation result (ES, Hola) in the second area 140b. The electronic apparatus 100 may display the fifth translation result (CN, Nihao) in the third area 140c.

As an example, the electronic apparatus 100 may display the first voice (EN, Hello) and the first translation result (FR, Bonjour) in the first area 140a. The electronic apparatus 100 may display the first voice (EN, Hello) and the second translation result (ES, Hola) in the second area 140b. The electronic apparatus 100 may display the first voice (EN, Hello) and the fifth translation result (CN, Nihao) in the third area 140c.

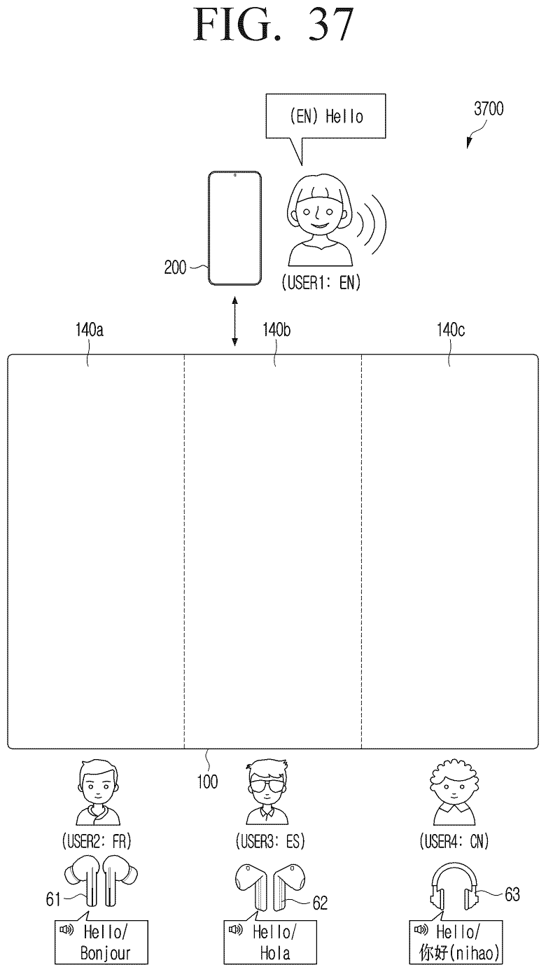

FIG. 37 is a diagram illustrating an operation for providing a translation result in audio through an electronic apparatus of a third structure according to an embodiment of the disclosure.

Embodiment 3700 of FIG. 37 may correspond to embodiment 900 in FIG. 9 and embodiment 3200 in FIG. 32. Redundant descriptions thereof will be omitted. The electronic apparatus 100 of FIG. 9 may include the display of the second structure, and the electronic apparatus 100 of FIG. 37 may include the display of the third structure. Embodiment 3700 assumes that the fourth user is present additionally. Descriptions associated therewith will be described in FIG. 36.

Referring to FIG. 37, the electronic apparatus 100 may transmit the audio signal corresponding to the first translation result (FR, Bonjour) to the first output device 61.

The electronic apparatus 100 may transmit the audio signal corresponding to the second translation result (ES, Hola) to the second output device 62.

The electronic apparatus 100 may transmit an audio signal corresponding to the fifth translation result (CN, Nihao) to a third output device 63. The third output device 63 may be a device determined to provide the translation result to the fourth user.

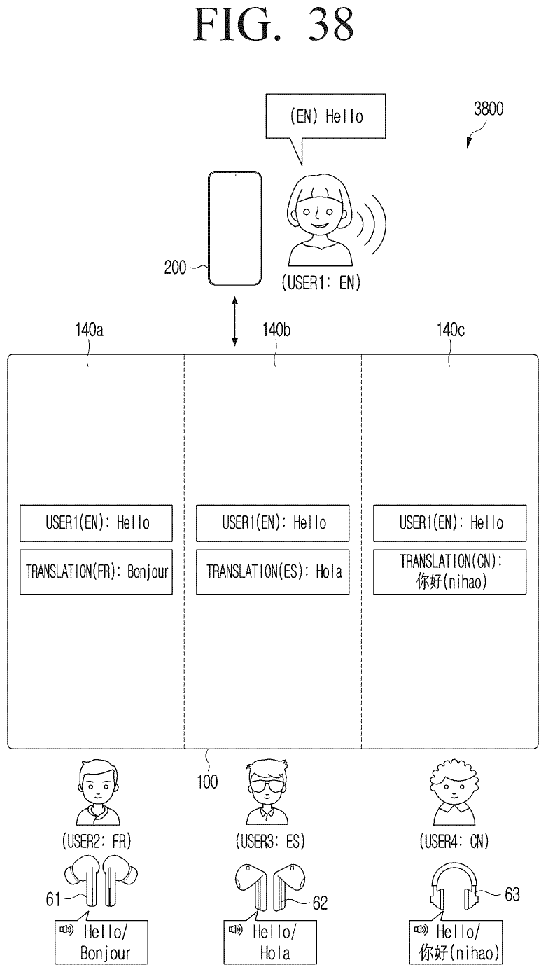

FIG. 38 is a diagram illustrating an operation for providing a translation result in an image and in audio through an electronic apparatus of a third structure according to an embodiment of the disclosure.

Embodiment 3800 in FIG. 38 may correspond to embodiment 1000 in FIG. 10 and embodiment 3300 in FIG. 33. Redundant descriptions thereof will be omitted. The electronic apparatus 100 in FIG. 10 may include the display of the second structure, and the electronic apparatus 100 in FIG. 38 may include the display of the third structure. Embodiment 3800 assumes that the fourth user is present additionally. Descriptions associated therewith will be described in FIG. 36.

Referring to FIG. 38, the electronic apparatus 100 may display the first translation result (FR, Bonjour) in the first area 140a and transmit the audio signal corresponding to the first translation result (FR, Bonjour) to the first output device 61.

The electronic apparatus 100 may display the second translation result (ES, Hola) in the second area 140b, and transmit the audio signal corresponding to the second translation result (ES, Hola) to the second output device 62.

The electronic apparatus 100 may display the fifth translation result (CN, Nihao) in the third area 140c, and transmit the audio signal corresponding to the fifth translation result (CN, Nihao) to the third output device 63.

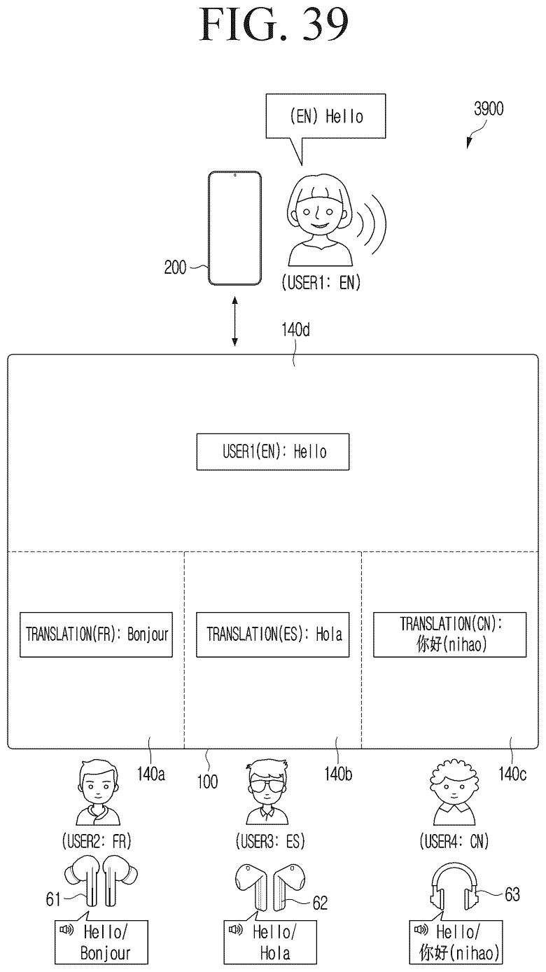

FIG. 39 is a diagram illustrating an operation for providing a translation result in an image and in audio through an electronic apparatus of a third structure according to an embodiment of the disclosure.

Embodiment 3900 in FIG. 39 may correspond to embodiment 1100 in FIG. 11 and embodiment 3400 in FIG. 34. Redundant descriptions thereof will be omitted. The electronic apparatus 100 in FIG. 11 may include the display of the second structure, and the electronic apparatus 100 in FIG. 39 may include the display of the third structure. Embodiment 3900 assumes that the fourth user is present additionally. Descriptions associated therewith will be described in FIG. 36.

Referring to FIG. 39, the electronic apparatus 100 may display only the first translation result (FR, Bonjour) in the first area 140a. The electronic apparatus 100 may display only the second translation result (ES, Hola) in the second area 140b. The electronic apparatus 100 may display only the fifth translation result (CN, Nihao) in the third area 140c. The electronic apparatus 100 may display the first voice (EN, Hello) in the fourth area 140d.

As an example, the second area 140b may be present at the left side of the third area 140c. The first area 140a may be present at the left side of the second area 140b. The fourth area 140d may be present at an upper side of the first area 140a, the second area 140b, and the third area 140c.

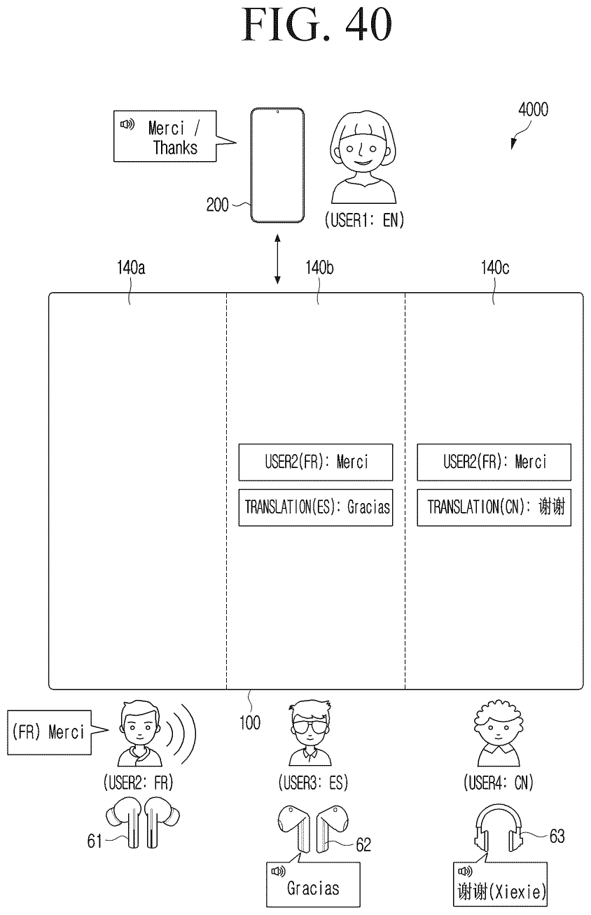

FIG. 40 is a diagram illustrating an operation of an electronic apparatus of a third structure not outputting a received voice and providing only a translation result according to an embodiment of the disclosure.

Referring to FIG. 40, embodiment 4000 may correspond to embodiment 2800 in FIG. 28 and embodiment 3500 in FIG. 35. Redundant descriptions thereof will be omitted. The electronic apparatus 100 in FIG. 28 may include the display of the second structure, and the electronic apparatus 100 in FIG. 40 may include the display of the third structure. Embodiment 4000 assumes that the fourth user is present additionally. Descriptions associated therewith will be described in FIG. 36.

The electronic apparatus 100 may obtain a sixth translation result (CN, Xiexie) in the fourth language based on the fourth voice (FR, Merci).

The electronic apparatus 100 may not display the fourth voice (FR, Merci) in the first area 140a.

The electronic apparatus 100 may display the fourth translation result (ES, Gracias) in the second area 140b, and transmit the audio signal corresponding to the fourth translation result (ES, Gracias) to the second output device 62.

The electronic apparatus 100 may display the sixth translation result (CN, Xiexie) in the third area 140c, and transmit an audio signal corresponding to the sixth translation result (CN, Xiexie) to the third output device 63.

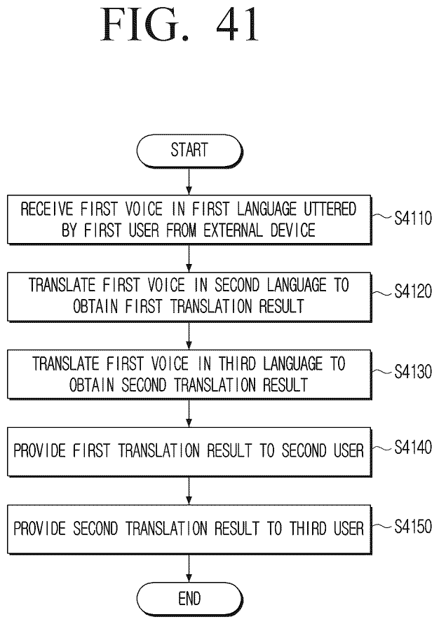

FIG. 41 is a diagram illustrating a controlling method of an electronic apparatus according to an embodiment of the disclosure.

Referring to FIG. 41, a method of controlling the electronic apparatus 100 may include receiving the first voice of the first language uttered by the first user from the external device 200 at operation S4110, translating the first voice in the second language to obtain the first translation result at operation S4120, translating the first voice in the third language to obtain the second translation result at operation S4130, providing the first translation result to the second user at operation S4140, and providing the second translation result to the third user at operation S4150.

The first translation result may include at least one of the second text or the second voice translated based on the second language, and the second translation result may include at least one of the third text or the third voice translated based on the third language.

The obtaining the first translation result and the second translation result may include obtaining, based on the first voice being received, the first text of the first voice, translating the first text in the second language to obtain the second text, and translating the first text in the third language to obtain the third text.

The electronic apparatus 100 may include the display, and the providing the first translation result and the second translation result may include determining the first area corresponding to the second user among the entire area of the display, determining the second area corresponding to the third user among the entire area of the display, displaying the second text in the first area, and displaying the third text in the second area.

The providing the first translation result and the second translation result may include displaying the first text and the second text in the first area together, and displaying the first text and the third text in the second area together.

The first area may be the left area of the second area.

The obtaining the first translation result and the second translation result may include obtaining the second voice corresponding to the second text based on the voice generation function for converting text data to audio data, and obtaining the third voice corresponding to the third text based on the voice generation function.

The obtaining the first translation result and the second translation result may include obtaining the second voice based on the first voice and the second text, and obtaining the third voice based on the first voice and the third text.

The providing the first translation result and the second translation result may include determining the first output device corresponding to the second user, determining the second output device corresponding to the third user, transmitting the second voice to the first output device, and transmitting the third voice to the second output device.

The first output device or the second output device may be one of least one speaker included in the electronic apparatus 100 or an earphone connectable to the electronic apparatus 100.

Methods according to the various embodiments of the disclosure described above may be implemented in an application form installable in an electronic apparatus of the related art.

Methods according to the various embodiments of the disclosure described above may be implemented with only a software upgrade, or a hardware upgrade for the electronic apparatus of the related art.

The various embodiments of the disclosure described above may be performed through an embedded server provided in the electronic apparatus, or an external server of at least one of the electronic apparatus and a display apparatus.

According to an embodiment of the disclosure, the various embodiments described above may be implemented with software including instructions stored in a machine-readable storage media (e.g., computer). The machine may call instructions stored in a storage medium, and as an apparatus operable according to the called instructions, may include the electronic apparatus according to the above-mentioned embodiments. Based on the instructions being executed by the processor, the processor may directly or using other elements under the control of the processor perform a function corresponding to the instructions. The instructions may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

According to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., compact disc read only memory (CD-ROM)), or distributed online through an application store. In the case of online distribution, at least a portion of the computer program product may be stored at least temporarily in a storage medium, such as a server of a manufacturer, a server of an application store, or memory of a relay server, or temporarily generated.

Each of the elements (e.g., a module or a program) according to various embodiments described above may be configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective relevant elements prior to integration. Operations performed by a module, a program, or another element, in accordance with various embodiments of the disclosure, may be executed sequentially, in a parallel, repetitively, or in a heuristic manner, or at least a portion of the operations may be executed in a different order, omitted or a different operation may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and full scope of the disclosure as defined by the appended claims and their equivalents.

What is claimed is:

1. An electronic apparatus comprising:
memory, comprising one or more storage media, storing instructions;
a communication circuit connected to an external device; and
at least one processor including processing circuitry communicatively coupled to the memory and the communication circuit,
wherein the instructions, when executed by the at least one processor individually or collectively, cause the electronic apparatus to:
receive a first voice of a first language uttered by a first user from the external device through the communication circuit,
translate the first voice in a second language to obtain a first translation result,
translate the first voice in a third language to obtain a second translation result,
provide the first translation result to a second user, and
provide the second translation result to a third user.

2. The electronic apparatus of claim 1,
wherein the first translation result includes:
at least one of a second text or a second voice translated based on the second language, and
wherein the second translation result includes:
at least one of a third text or a third voice translated based on the third language.

3. The electronic apparatus of claim 2, wherein the instructions, when executed by the at least one processor individually or collectively, further cause the electronic apparatus to:
based on the first voice being received, obtain a first text of the first voice,
translate the first text in the second language to obtain the second text, and
translate the first text in the third language to obtain the third text.

4. The electronic apparatus of claim 3,
wherein the electronic apparatus includes:
a display, and
wherein the instructions, when executed by the at least one processor individually or collectively, further cause the electronic apparatus to:
determine a first area corresponding to the second user among an entire area of the display,
determine a second area corresponding to the third user among the entire area of the display,
display the second text in the first area, and
display the third text in the second area.

5. The electronic apparatus of claim 4, wherein the instructions, when executed by the at least one processor individually or collectively, further cause the electronic apparatus to:
display the first text and the second text in the first area together, and
display the first text and the third text in the second area together.

6. The electronic apparatus of claim 4, wherein the first area is a left area of the second area.

7. The electronic apparatus of claim 3, wherein the instructions, when executed by the at least one processor individually or collectively, further cause the electronic apparatus to:
obtain the second voice corresponding to the second text based on a voice generation function for converting text data to audio data, and
obtain the third voice corresponding to the third text based on the voice generation function.

8. The electronic apparatus of claim 7, wherein the instructions, when executed by the at least one processor individually or collectively, further cause the electronic apparatus to:
obtain the second voice based on the first voice and the second text, and
obtain the third voice based on the first voice and the third text.

9. The electronic apparatus of claim 7, wherein the instructions, when executed by the at least one processor individually or collectively, further cause the electronic apparatus to:
determine a first output device corresponding to the second user,
determine a second output device corresponding to the third user,
transmit the second voice to the first output device, and
transmit the third voice to the second output device.

10. The electronic apparatus of claim 9, wherein the first output device or the second output device is:
one of at least one speaker included in the electronic apparatus or an earphone connectable to the electronic apparatus.

11. A method of controlling an electronic apparatus, the method comprising:
receiving a first voice of a first language uttered by a first user from an external device;
translating the first voice in a second language to obtain a first translation result;
translating the first voice in a third language to obtain a second translation result;
providing the first translation result to a second user; and
providing the second translation result to a third user.

12. The method of claim 11,
wherein the first translation result includes:
at least one of a second text or a second voice translated based on the second language, and
wherein the second translation result includes:
at least one of a third text or a third voice translated based on the third language.

13. The method of claim 12, wherein the obtaining of the first translation result and the second translation result includes:
based on the first voice being received, obtaining a first text of the first voice;
translating the first text in a second language to obtain the second text; and
translating the first text in a third language to obtain the third text.

14. The method of claim 13,
wherein the electronic apparatus includes:
a display, and
wherein the providing of the first translation result and the second translation result includes:
determining a first area corresponding to the second user among an entire area of the display,
determining a second area corresponding to the third user among the entire area of the display,
displaying the second text in the first area, and
displaying the third text in the second area.

15. The method of claim 14, wherein the providing of the first translation result and the second translation result includes:
displaying the first text and the second text in the first area together; and
displaying the first text and the third text in the second area together.

16. The method of claim 14, wherein the first area is a left area of the second area.

17. The method of claim 13, further comprising:
obtaining the second voice corresponding to the second text based on a voice generation function for converting text data to audio data; and
obtaining the third voice corresponding to the third text based on the voice generation function.

18. The method of claim 17, further comprising:
obtaining the second voice based on the first voice and the second text, and obtain the third voice based on the first voice and the third text.

19. One or more non-transitory computer-readable storage media storing one or more computer programs including computer-executable instruction that, when executed by one or more processors of an electronic apparatus individually or collectively, cause the electronic apparatus to perform operations, the operations comprising:
receiving a first voice of a first language uttered by a first user from an external device;
translating the first voice in a second language to obtain a first translation result;
translating the first voice in a third language to obtain a second translation result;
providing the first translation result to a second user; and
providing the second translation result to a third user.

20. The one or more non-transitory computer-readable storage media of claim 19,
wherein the first translation result includes:
at least one of a second text or a second voice translated based on the second language, and
wherein the second translation result includes:
at least one of a third text or a third voice translated based on the third language.
